(19) United States
(12) Patent Application Publication
(10) Pub. No.: US 2025/0225728 A1
(43) Pub. Date: Jul. 10, 2025

(54) GEOMETRIC DRIVABLE SURFACE ESTIMATION

(71) Applicant: Luminar Technologies, Inc., Orlando, FL (US)

(72) Inventors: Amey Sutavani, Sunnyvale, CA (US); Anton Sotnikov, Mountain View, CA (US); Prateek Mehrotra, Santa Clara, CA (US); Igor Tryndin, Fremont, CA (US)

(21) Appl. No.: 18/989,403

(22) Filed: Dec. 20, 2024

Related U.S. Application Data
(60) Provisional application No. 63/618,609, filed on Jan. 8, 2024.

(51) Int. Cl. G06T 17/20; G01S 17/89

(52) U.S. Cl. CPC G06T 17/20; G01S 17/89

(57) ABSTRACT

A point cloud generated at least in part using a lidar sensor is received. A geometric mesh based on the point cloud is determined. A seed geometric face formed in the geometric mesh is selected based on one or more seed selection criteria. Starting from the seed geometric face, neighboring geometric faces of the geometric mesh that meet one or more relative neighbor selection criteria are iteratively selected into a region group, and an operable region indicated by the region group is detected.

### CROSS REFERENCE TO OTHER APPLICATIONS

This application claims priority to U.S. Provisional Patent Application No. 63/618,609 entitled GEOMETRIC DRIVABLE SURFACE ESTIMATION filed Jan. 8, 2024 which is incorporated herein by reference for all purposes.

### BACKGROUND OF THE INVENTION

Light detection and ranging (lidar) is a technology that can be used to measure distances to remote targets. Typically, a lidar system includes a light source and an optical receiver. The light source can include, for example, a laser which emits light having a particular operating wavelength. The operating wavelength of a lidar system may lie, for example, in the infrared, visible, or ultraviolet portions of the electromagnetic spectrum. The light source emits light towards a target which scatters the light, and some of the scattered light is received back at the receiver. The system determines the distance to the target based on one or more characteristics associated with the received light. For example, the lidar system may determine the distance to the target based on the time of flight for a pulse of light emitted by the light source to travel to the target and back to the lidar system. By scanning and capturing measurements for a particular field of regard, a collection of depth-mapped points determined by a lidar system can be used to create a point cloud.

### BRIEF DESCRIPTION OF THE DRAWINGS

Various embodiments of the invention are disclosed in the following detailed description and the accompanying drawings.

FIG. 1 illustrates an example light detection and ranging (lidar) system.

FIG. 2 illustrates an example scan pattern produced by a lidar system.

FIG. 3 illustrates an example lidar system with an example rotating polygon mirror.

FIG. 4 illustrates an example light-source field of view (FOVL) and receiver field of view (FOVR) for a lidar system.

FIG. 5 illustrates an example unidirectional scan pattern that includes multiple pixels and multiple scan lines.

FIG. 6 illustrates an example lidar system with a light source that emits pulses of light and local-oscillator (LO) light.

FIG. 7 illustrates an example receiver and an example voltage signal corresponding to a received pulse of light.

FIG. 8 is a flow chart illustrating an embodiment of a process for estimating the drivable surface of an environment using a lidar device.

FIG. 9 is a flow chart illustrating an embodiment of a process for generating a geometric mesh for estimating the surface of a surrounding environment.

FIG. 10 is a flow chart illustrating an embodiment of a process for grouping a geometric mesh into regions.

FIG. 11 is a flow chart illustrating an embodiment of a process for selecting a group of faces into a region group using a seed face.

FIG. 12 is a flow chart illustrating an embodiment of a process for updating a geometric mesh for estimating the surface of a surrounding environment.

FIG. 13 is a flow chart illustrating an embodiment of a process for evaluating the change in a scene to determine mesh reuse.

FIG. 14 is a flow chart illustrating an embodiment of a process for evaluating the change in a point of a scene to determine mesh reuse.

FIG. 15 illustrates an example computer system.

FIG. 16 is a diagram illustrating a visual example of a two-dimensional flat geometric mesh determined using lidar sensor detection data.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Geometric surface estimation is disclosed. Using the disclosed techniques and systems, a lidar-based system can determine an estimated geometric surface of the surrounding environment. The estimated geometric surface can then be further analyzed to determine the drivable surface including assigning drivable coefficients and/or properties for different portions of the determined surface. For example, after scanning a field of regard, a point cloud can be generated based on captured lidar measurements. The lidar data is then analyzed to determine a geometric mesh corresponding to a scanned field of regard. The vertices of the geometric mesh can be based on two lidar data values, such as the azimuth and altitude (or elevation) measurements, for each measured point. In various embodiments, the triangulation of the geometric mesh is determined independent of corresponding range attribute of the points. For example, the point cloud can be triangulated only in two dimensions based on the azimuth and elevation attributes of each point. The range attribute of each point can then be added to the vertices of the triangles to generate a three-dimensional mesh. The resulting geometric mesh and its faces are then analyzed to determine the corresponding surface and properties for regions of the surface such as drivable areas. For example, faces of the determined geometric mesh are analyzed to determine their operable or drivable properties or characteristics.

In some embodiments, regions of the determined geometric mesh are analyzed by identifying and selecting one or more seed faces and then identifying and selecting neighboring faces that share the same properties into a region group. For example, seed faces can be selected by analyzing the normal and/or the altitude of the geometric faces. Once a seed face that has a normal that approximates the normal of a drivable surface is selected, neighboring faces are analyzed and grouped into the same region group based on selection criteria. In some embodiments, the selection criteria are based on evaluating the difference between the direction of normal of a potential face and the normal of the seed face, neighboring face(s), and/or the orientation of the lidar sensor. For example, faces near the lidar sensor can be grouped based on their differences compared to the orientation of the lidar sensor and faces farther from the lidar sensor can be grouped based on their differences compared to those of their neighboring faces. Other approaches and selection criteria are appropriate as well and a variety of factors including neighboring faces, elevation, distance, intensity, relation to horizon, past values, etc. are appropriate for use in the selection criteria.

In various embodiments, the normal of a geometric face can be used to determine a surface region grouping. For example, in the event the inner product of the normal of a neighboring face and the normal of a reference (or seed) face falls within a configured threshold range, the neighboring face is included in the region group of contiguous, smooth drivable faces that includes the reference face. In contrast, in the event the inner product is outside the configured threshold range, the neighboring face can correspond to portions of the surface where the slope of the surface corresponds to an obstacle or a non-smooth surface for driving. The impacted neighboring face can correspond to an obstacle such as a wall, a curb, road debris (such as a tire, a cardboard box, the edge of a pothole, etc.), or another object outside of the regions of the surface that are drivable. The impacted face is identified as not drivable and excluded from the region group of drivable (or operable) faces. In some embodiments, the face is included in a different region group such as a region group that corresponds to a detected obstacle.

In some embodiments, various additional steps and/or techniques including optimization techniques can be applied to improve the surface estimation results including geometric surface determination and drivable surface determination results. For example, the method applied to triangulate and/or convert the point cloud into a geometric mesh can introduce irregular faces and/or connect areas in the scene that are not physically connected. In some embodiments, one or more filtering steps can be performed to improve the geometric mesh, such as filtering by edge length, point intensity values or differences, face area, face normal, vertex height, etc. Similarly, one or more refinement steps can be applied to determine the drivable surface such as the selection criteria for identifying seed faces. In various embodiments, additional heuristics can be applied for improved accuracy, for example, by applying heuristics to reduce noise.

In some embodiments, the determination of the geometric mesh is optimized and the mesh is only updated when needed. For example, the geometric mesh and underlying point cloud are analyzed to determine whether the geometric mesh needs to be reconstructed and/or which portions of the geometric mesh need to be reconstructed. In some embodiments, one instance of the geometric mesh and its faces (such as the initial mesh and its faces) can be determined using measurements from the majority of the points from a determined point cloud. On subsequent frames, the new point data can be evaluated to determine whether a sufficient change has occurred before recalculating the geometric mesh. In some embodiments, the geometric mesh is only reconstructed in the event the change between point values of different frames differs, for example, by more than a configured threshold value. In some embodiments, the determined change between frames is based on the number of points of the point cloud that have changed and are not stale or invalid. For example, a point can be marked as invalid or stale when its azimuth and/or altitude (or elevation) value changes by more than a threshold value. Once the number (or percentage) of invalid or stale points exceeds a threshold value, the geometric mesh corresponding to the region with the invalid points is reconstructed. In some embodiments, only portions of the scene that are identified as requiring updates and/or only portions of the scene that correspond to stale regions are updated. For example, the foreground or surface areas near the lidar sensor, which may change more frequently, may require more frequent updates to the geometric mesh than surface areas corresponding to the horizon or regions further off in the distance, which may change less frequently.

In some embodiments, a point cloud generated at least in part using a lidar sensor is received. For example, a lidar sensor is used to scan a field of regard and the resulting measurement data is used to construct a point cloud. Each point of the point cloud can have a corresponding azimuth, altitude, and distance value. For example, the azimuth and altitude values can correspond to angular values that represent the angular location of the corresponding points with respect to the lidar system. In some embodiments, the altitude values are elevation values. In some embodiments, each point includes additional measurements such as an intensity measurement that can differ depending on the target material.

In some embodiments, a geometric mesh based on the point cloud is determined. For example, the point cloud data is used to generate a geometric mesh. The faces of the mesh can be constructed of polygons, such as triangles, where the vertices of the faces correspond to points of the received point cloud. In some embodiments, the triangulation of the received point cloud into a geometric mesh is performed using a two-dimensional representation of the point cloud. For example, a geometric mesh can be determined independent of point cloud distance measurements by using each point's azimuth and altitude values. In various embodiments, the mesh can be refined by filtering out irregular faces, such as faces with edges that exceed a certain threshold value. Once the point cloud has been converted to an initial two-dimensional geometric mesh, the distance values can be added to each mesh vertex based on point cloud distance measurements. In some embodiments, other measurement values, such as intensity, are also associated with the vertices of the geometric mesh.

In some embodiments, a seed geometric face formed in the geometric mesh is selected based on one or more seed selection criteria. For example, faces of the geometric mesh are selected into different regions by starting with one or more seed geometric faces. The seed geometric faces can be selected based on the face normals and/or heights. In some embodiments, a face with the lowest average vertex height among a set of faces is selected as a seed geometric face. In some embodiments, the seed selection criteria include evaluating the normal vectors of the faces to identify faces that face upwards, such as along the Z-axis of the scene and/or lidar system.

In some embodiments, starting from the seed geometric face, neighboring geometric faces of the geometric mesh that meet one or more relative neighbor selection criteria are iteratively selected into a region group. For example, starting from a seed face, the faces are flooded to select neighboring faces that are similar to the seed. Faces that are similar to the seed and/or their neighbors on subsequent iterations are selected and grouped in the same region group. In some embodiments, the relative neighbor selection criteria include evaluating the change in slope between neighboring faces and/or evaluating the normal of the neighboring faces relative to a reference face, such as a seed face. In some embodiments, an operable region indicated by the region group is detected. For example, the faces grouped into the same region with normals that align with the lidar system's Z-axis are grouped into a drivable or operable region. Faces in the drivable region group correspond to the regions of the scanned surface that are drivable. In some embodiments, the faces and/or vertices of the faces are assigned drivable (or operable) parameters such as a drivable flag and/or drivable coefficients. In various embodiments, an assigned drivable coefficient can correspond to the level of drivability. Other drivable parameters can include a category and/or description of the material associated with a region of the scanned surface.

In some embodiments, a first detection data generated at least in part using a lidar sensor is received. For example, detection data from a point cloud generated using a lidar sensor is received. The received detection data can correspond to azimuth and altitude values for points of the generated point cloud. In some embodiments, a first two-dimensional geometric mesh based at least in part on the first detection data is determined. For example, a two-dimensional geometric mesh is determined based on the azimuth and altitude values of the received first detection data. The two-dimensional geometric mesh can be constructed of faces such as triangles where the vertices correspond to points of the point cloud. In some embodiments, the two-dimensional geometric mesh is based on other detection values but is independent on the distance measurements associated with the point cloud. In some embodiments, a first three-dimensional geometric mesh based at least in part on the first two-dimensional geometric mesh is generated. For example, a distance value is added to each vertex of the two-dimensional geometric mesh to expand the geometric mesh to a three-dimensional geometric mesh. In various embodiments, the values for the third dimension are based on the generated point cloud and correspond to lidar distance measurements.

In some embodiments, a second detection data generated at least in part using the lidar sensor is received. For example, a subsequent frame of lidar data is determined and a revised point cloud is generated using the lidar detection data. The subsequent frame reflects changes in the field of regard compared to a previous frame. For example, the position of the lidar sensor may move as the associated vehicle moves and/or objects in the surrounding environment may move. The subsequent frame may also reflect that no significant changes occurred compared to a previous frame. For example, significant portions including even the entire relevant surrounding environment may have minimal to no changes. In various scenarios, depending on the changes in the surrounding environment, a new geometric mesh may be required to accurately reflect the corresponding surface estimation.

In some embodiments, a determination is made whether to reuse at least a portion of the first two-dimensional geometric mesh based on an analyzed difference between the second detection data and the first detection data. For example, the first and second detection data are analyzed to determine the extent of the changes associated with the scanned field of regard between different lidar frames. In some embodiments, the analysis is based on evaluating changes in two-dimensions, such as changes to the generated point cloud data corresponding to changes in azimuth and altitude values. The difference between the second detection data and the first detection data can be determined based on the number of points that changed and the extent of the changes for each point. In some embodiments, a second three-dimensional geometric mesh based at least in part on the first two-dimensional geometric mesh is generated. For example, in the event the changes do not impact the validity of the existing three-dimensional geometric mesh, the existing three-dimensional geometric mesh can be reused. However, in the event the changes do impact the validity of the existing three-dimensional geometric mesh, at least portions of the three-dimensional geometric mesh are reconstructed to generate a second three-dimensional geometric mesh that accurately estimates the surface of the surrounding environment. For example, portions or regions corresponding to stale or invalid vertices based on the analyzed difference between the second detection data and the first detection data can be reconstructed by first determining a revised two-dimensional geometric mesh and then expanding the revised two-dimensional geometric mesh to a three-dimensional geometric mesh. The revised two-dimensional geometric mesh can be expanded to three dimensions using the corresponding updated values for the third dimension, such as updated distances values. In some embodiments, the entire three-dimensional geometric mesh is reconstructed to generate a second three-dimensional geometric mesh rather than regenerating only stale regions.

In some embodiments, in the event the analyzed difference between the second detection data and the first detection data is not significant, an existing three-dimensional geometric mesh can be reused but the distance values may be updated as appropriate. For example, rather than completely reconstructing portions of the three-dimensional geometric mesh by determining a revised two-dimensional mesh, the existing three-dimensional geometric mesh is updated with refreshed values for the third dimension.

A lidar system operates in a vehicle and includes multiple “eyes,” each of which has its own field of regard, or an angular range over which the eye scans targets using pulses of light in accordance with a scan pattern. The fields of regard can combine along a certain dimension (e.g., horizontally) to define the overall field of regard of the lidar system. The lidar system then can use data received via both eyes to generate a point cloud or otherwise process the received data.

In a two-eye configuration of the lidar system, the two eyes can be housed together and scan the respective fields of regard via a shared window or separate windows, or the eyes can be housed separately. In the latter case, an assembly referred to as a “sensor head” can include a scanner, a receiver, and an optical element such as a collimator or a laser diode to generate or convey a beam of light.

Depending on the implementation, each eye of a lidar system can include a separate scanner (e.g., each eye can be equipped with a pivotable scan mirror to scan the field of regard vertically and another pivotable scan mirror to scan the field of regard horizontally), a partially shared scanner (e.g., each eye can be equipped with a pivotable scan mirror to scan the field of regard vertically, and a shared polygon mirror can scan the corresponding fields of regard horizontally, using different reflective surfaces), or a fully shared scanner (e.g., a pivotable planar mirror can scan the fields of regard vertically by reflecting incident beams at different regions on the reflective surface, and a shared polygon mirror can scan the corresponding fields of regard horizontally, using different reflective surfaces).

Different hardware configurations allow the lidar system to operate the eyes more independently of each other, as is the case with separate scanners, or less independently, as is the case with a fully shared scanner. For example, the two or more eyes may scan the respective fields of regard using similar or different scan patterns. In one implementation, the two eyes trace out the same pattern, but with a certain time differential to maintain angular separation between light-source fields of view and thereby reduce the probability of cross-talk events between the sensor heads. In another implementation, the two eyes scan the corresponding fields of regard according to different scan patterns, at least in some operational states (e.g., when the vehicle is turning right or left).

Further, according to one approach, two eyes of a lidar system are arranged so that the fields of regard of the eyes are adjacent and non-overlapping. For example, each field of regard can span approximately 60 degrees horizontally and 30 degrees vertically, so that the combined field of regard of the lidar system spans approximately 120 degrees horizontally and 30 degrees vertically. The corresponding scanners (or paths within a shared scanner) can point away from each other at a certain angle, for example, so that the respective fields of regard abut approximately at an axis corresponding to the forward-facing direction of the vehicle.

Alternatively, the lidar system can operate in a “cross-eyed” configuration to create an area of overlap between the fields of regard. The area of overlap can be approximately centered along the forward-facing direction or another direction, which in some implementations a controller can determine dynamically. In this implementation, the two sensor heads can yield a higher density of scan in the area that generally is more important. In some implementations, the fields of regard in a cross-eyed two-eye configuration are offset from each other by a half-pixel value, so that the area of overlap has twice as many pixels. In general, the fields of regard can overlap angularly or translationally. To reduce the probability of cross-talk events (e.g., the situation when a pulse emitted by the light source associated with the first eye is received by the receiver of the second eye), the lidar system can use output beams with different wavelengths.

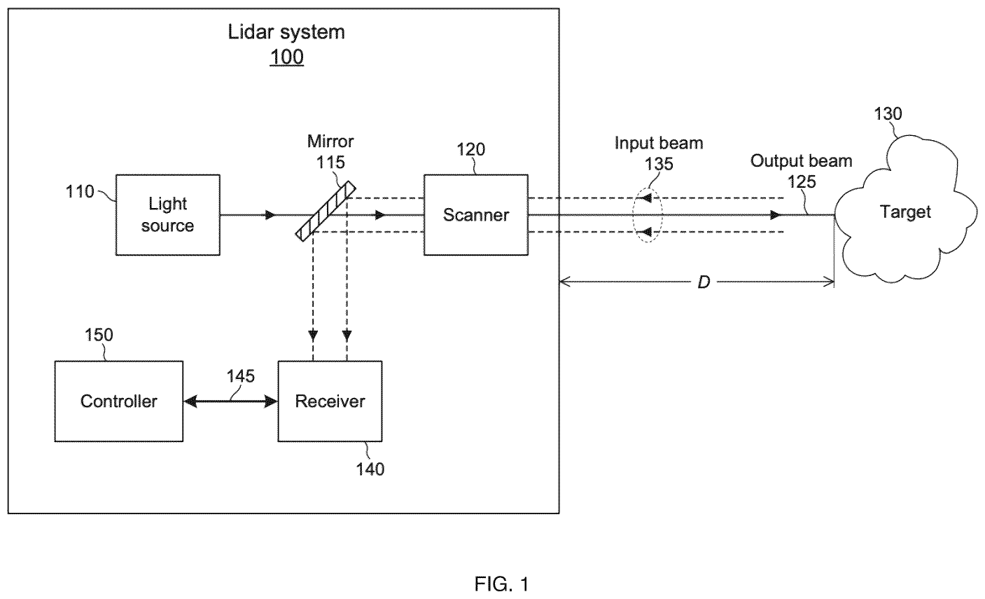

FIG. 1 illustrates an example light detection and ranging (lidar) system 100. In particular embodiments, a lidar system 100 may be referred to as a laser ranging system, a laser radar system, a LIDAR system, a lidar sensor, or a laser detection and ranging (LADAR or ladar) system. In particular embodiments, a lidar system 100 may include a light source 110, mirror 115, scanner 120, receiver 140, or controller 150. The light source 110 may include, for example, a laser which emits light having a particular operating wavelength in the infrared, visible, or ultraviolet portions of the electromagnetic spectrum. As an example, light source 110 may include a laser with one or more operating wavelengths between approximately 900 nanometers (nm) and 2100 nm. The light source 110 emits an output beam of light 125 which may be continuous wave (CW), pulsed, or modulated in any suitable manner for a given application. The output beam of light 125 is directed downrange toward a remote target 130. As an example, the remote target 130 may be located a distance D of approximately 1 m to 1 km from the lidar system 100.

Once the output beam 125 reaches the downrange target 130, the target may scatter or reflect at least a portion of light from the output beam 125, and some of the scattered or reflected light may return toward the lidar system 100. In the example of FIG. 1, the scattered or reflected light is represented by input beam 135, which passes through scanner 120 and is reflected by mirror 115 and directed to receiver 140. In particular embodiments, a relatively small fraction of the light from output beam 125 may return to the lidar system 100 as input beam 135. As an example, the ratio of input beam 135 average power, peak power, or pulse energy to output beam 125 average power, peak power, or pulse energy may be approximately 10⁻¹, 10⁻², 10⁻³, 10⁻⁴, 10⁻⁵, 10⁻⁶, 10⁻⁷, 10⁻⁸, 10⁻⁹, 10⁻¹⁰, 10⁻¹¹, or 10⁻¹². As another example, if a pulse of output beam 125 has a pulse energy of 1 microjoule (μJ), then the pulse energy of a corresponding pulse of input beam 135 may have a pulse energy of approximately 10 nanojoules (nJ), 1 nJ, 100 picojoules (pJ), 10 pJ, 1 pJ, 100 femtojoules (fJ), 10 fJ, 1 fJ, 100 attojoules (aJ), 10 aJ, 1 aJ, or 0.1 aJ. In some embodiments, the pulse energy of a pulse of input beam 135 can at times be as large as the pulse energy of a corresponding pulse of output beam 125.

In particular embodiments, output beam 125 may include or may be referred to as an optical signal, output optical signal, emitted optical signal, output light, emitted pulse of light, laser beam, light beam, optical beam, emitted beam, emitted light, or beam. In particular embodiments, input beam 135 may include or may be referred to as a received optical signal, received pulse of light, input pulse of light, input optical signal, return beam, received beam, return light, received light, input light, scattered light, or reflected light. As used herein, scattered light may refer to light that is scattered or reflected by a target 130. As an example, an input beam 135 may include: light from the output beam 125 that is scattered by target 130; light from the output beam 125 that is reflected by target 130; or a combination of scattered and reflected light from target 130.

In particular embodiments, receiver 140 may receive or detect photons from input beam 135 and produce one or more representative signals. For example, the receiver 140 may produce an output electrical signal 145 that is representative of the input beam 135, and the electrical signal 145 may be sent to controller 150. In particular embodiments, receiver 140 or controller 150 may include a processor, computing system (e.g., an ASIC or FPGA), or other suitable circuitry. A controller 150 may be configured to analyze one or more characteristics of the electrical signal 145 from the receiver 140 to determine one or more characteristics of the target 130, such as its distance downrange from the lidar system 100. This may be done, for example, by analyzing a time of flight or a frequency or phase of a transmitted beam of light 125 or a received beam of light 135. If lidar system 100 measures a time of flight of T (e.g., T represents a round-trip time of flight for an emitted pulse of light to travel from the lidar system 100 to the target 130 and back to the lidar system 100), then the distance D from the target 130 to the lidar system 100 may be expressed as D=c·T/2, where c is the speed of light (approximately 3.0×10⁸ m/s). As an example, if a time of flight is measured to be T=300 ns, then the distance from the target 130 to the lidar system 100 may be determined to be approximately D=45.0 m. As another example, if a time of flight is measured to be T=1.33 μs, then the distance from the target 130 to the lidar system 100 may be determined to be approximately D=199.5 m. In particular embodiments, a distance D from lidar system 100 to a target 130 may be referred to as a distance, depth, or range of target 130. As used herein, the speed of light c refers to the speed of light in any suitable medium, such as for example in air, water, or vacuum. As an example, the speed of light in vacuum is approximately 2.9979×10⁸ m/s, and the speed of light in air (which has a refractive index of approximately 1.0003) is approximately 2.9970×10⁸ m/s.

In particular embodiments, light source 110 may include a pulsed or CW laser. As an example, light source 110 may be a pulsed laser configured to produce or emit pulses of light with a pulse duration or pulse width of approximately 10 picoseconds (ps) to 100 nanoseconds (ns). The pulses may have a pulse duration of approximately 100 ps, 200 ps, 400 ps, 1 ns, 2 ns, 5 ns, 10 ns, 20 ns, 50 ns, 100 ns, or any other suitable pulse duration. As another example, light source 110 may be a pulsed laser that produces pulses with a pulse duration of approximately 1-5 ns. As another example, light source 110 may be a pulsed laser that produces pulses at a pulse repetition frequency of approximately 80 kHz to 10 MHz or a pulse period (e.g., a time between consecutive pulses) of approximately 100 ns to 12.5 μs. In particular embodiments, light source 110 may have a substantially constant pulse repetition frequency, or light source 110 may have a variable or adjustable pulse repetition frequency. As an example, light source 110 may be a pulsed laser that produces pulses at a substantially constant pulse repetition frequency of approximately 640 kHz (e.g., 640,000 pulses per second), corresponding to a pulse period of approximately 1.56 μs. As another example, light source 110 may have a pulse repetition frequency (which may be referred to as a repetition rate) that can be varied from approximately 200 kHz to 3 MHz. As used herein, a pulse of light may be referred to as an optical pulse, a light pulse, or a pulse.

In particular embodiments, light source 110 may include a pulsed or CW laser that produces a free-space output beam 125 having any suitable average optical power. As an example, output beam 125 may have an average power of approximately 1 milliwatt (mW), 10 mW, 100 mW, 1 watt (W), 10 W, or any other suitable average power. In particular embodiments, output beam 125 may include optical pulses with any suitable pulse energy or peak optical power. As an example, output beam 125 may include pulses with a pulse energy of approximately 0.01 μJ, 0.1 μJ, 0.5 μJ, 1 μJ, 2 μJ, 10 μJ, 100 μJ, 1 mJ, or any other suitable pulse energy. As another example, output beam 125 may include pulses with a peak power of approximately 10 W, 100 W, 1 kW, 5 kW, 10 kW, or any other suitable peak power. The peak power (Pₚₑₐₖ) of a pulse of light can be related to the pulse energy (E) by the expression E=Pₚₑₐₖ·Δt, where Δt is the duration of the pulse, and the duration of a pulse may be defined as the full width at half maximum duration of the pulse. For example, an optical pulse with a duration of 1 ns and a pulse energy of 1 μJ has a peak power of approximately 1 kW. The average power (Pₐᵥ) of an output beam 125 can be related to the pulse repetition frequency (PRF) and pulse energy by the expression Pₐᵥ=PRF·E. For example, if the pulse repetition frequency is 500 kHz, then the average power of an output beam 125 with 1-μJ pulses is approximately 0.5 W.

In particular embodiments, light source 110 may include a laser diode, such as for example, a Fabry-Perot laser diode, a quantum well laser, a distributed Bragg reflector (DBR) laser, a distributed feedback (DFB) laser, a vertical-cavity surface-emitting laser (VCSEL), a quantum dot laser diode, a grating-coupled surface-emitting laser (GCSEL), a slab-coupled optical waveguide laser (SCOWL), a single-transverse-mode laser diode, a multi-mode broad area laser diode, a laser-diode bar, a laser-diode stack, or a tapered-stripe laser diode. As an example, light source 110 may include an aluminum-gallium-arsenide (AlGaAs) laser diode, an indium-gallium-arsenide (InGaAs) laser diode, an indium-gallium-arsenide-phosphide (InGaAsP) laser diode, or a laser diode that includes any suitable combination of aluminum (Al), indium (In), gallium (Ga), arsenic (As), phosphorous (P), or any other suitable material. In particular embodiments, light source 110 may include a pulsed or CW laser diode with a peak emission wavelength between 1200 nm and 1600 nm. As an example, light source 110 may include a current-modulated InGaAsP DFB laser diode that produces optical pulses at a wavelength of approximately 1550 nm. As another example, light source 110 may include a laser diode that emits light at a wavelength between 1500 nm and 1510 nm.

In particular embodiments, light source 110 may include a pulsed or CW laser diode followed by one or more optical-amplification stages. For example, a seed laser diode may produce a seed optical signal, and an optical amplifier may amplify the seed optical signal to produce an amplified optical signal that is emitted by the light source 110. In particular embodiments, an optical amplifier may include a fiber-optic amplifier or a semiconductor optical amplifier (SOA). For example, a pulsed laser diode may produce relatively low-power optical seed pulses which are amplified by a fiber-optic amplifier. As another example, a light source 110 may include a fiber-laser module that includes a current-modulated laser diode with an operating wavelength of approximately 1550 nm followed by a single-stage or a multi-stage erbium-doped fiber amplifier (EDFA) or erbium-ytterbium-doped fiber amplifier (EYDFA) that amplifies the seed pulses from the laser diode. As another example, light source 110 may include a continuous-wave (CW) or quasi-CW laser diode followed by an external optical modulator (e.g., an electro-optic amplitude modulator). The optical modulator may modulate the CW light from the laser diode to produce optical pulses which are sent to a fiber-optic amplifier or SOA. As another example, light source 110 may include a pulsed or CW seed laser diode followed by a semiconductor optical amplifier (SOA). The SOA may include an active optical waveguide configured to receive a seed optical signal (e.g., pulses of light or CW light) from the seed laser diode and amplify the seed optical signal as it propagates through the waveguide. For example, the seed laser diode may produce relatively low-power seed optical pulses, and the SOA may amplify each seed optical pulse to produce an emitted pulse of light. The optical gain of the SOA may be provided by pulsed or direct-current (DC) electrical current supplied to the SOA. The SOA may be integrated on the same chip as the seed laser diode, or the SOA may be a separate device with an anti-reflection coating on its input facet or output facet. As another example, light source 110 may include a seed laser diode followed by an SOA, which in turn is followed by a fiber-optic amplifier. For example, the seed laser diode may produce relatively low-power seed optical pulses which are amplified by the SOA, and the fiber-optic amplifier may further amplify each of the optical pulses to produce emitted pulses of light.

In particular embodiments, light source 110 may include a direct-emitter laser diode. A direct-emitter laser diode (which may be referred to as a direct emitter) may include a laser diode which produces light that is not subsequently amplified by an optical amplifier. A light source 110 that includes a direct-emitter laser diode may not include an optical amplifier, and the output light produced by a direct emitter may not be amplified after it is emitted by the laser diode. The light produced by a direct-emitter laser diode (e.g., optical pulses, CW light, or frequency-modulated light) may be emitted directly as a free-space output beam 125 without being amplified. A direct-emitter laser diode may be driven by an electrical power source that supplies current pulses to the laser diode, and each current pulse may result in the emission of an output optical pulse.

In particular embodiments, light source 110 may include a diode-pumped solid-state (DPSS) laser. A DPSS laser (which may be referred to as a solid-state laser) may refer to a laser that includes a solid-state, glass, ceramic, or crystal-based gain medium that is pumped by one or more pump laser diodes. The gain medium may include a host material that is doped with rare-earth ions (e.g., neodymium, erbium, ytterbium, or praseodymium). For example, a gain medium may include a yttrium aluminum garnet (YAG) crystal that is doped with neodymium (Nd) ions, and the gain medium may be referred to as a Nd:YAG crystal. A DPSS laser with a Nd:YAG gain medium may produce light at a wavelength between approximately 1300 nm and approximately 1400 nm, and the Nd:YAG gain medium may be pumped by one or more pump laser diodes with an operating wavelength between approximately 730 nm and approximately 900 nm. A DPSS laser may be a passively Q-switched laser that includes a saturable absorber (e.g., a vanadium-doped crystal that acts as a saturable absorber). Alternatively, a DPSS laser may be an actively Q-switched laser that includes an active Q-switch (e.g., an acousto-optic modulator or an electro-optic modulator). A passively or actively Q-switched DPSS laser may produce output optical pulses that form an output beam 125 of a lidar system 100.

In particular embodiments, an output beam of light 125 emitted by light source 110 may be a collimated optical beam having any suitable beam divergence, such as for example, a full-angle beam divergence of approximately 0.5 to 10 milliradians (mrad). A divergence of output beam 125 may refer to an angular measure of an increase in beam size (e.g., a beam radius or beam diameter) as output beam 125 travels away from light source 110 or lidar system 100. In particular embodiments, output beam 125 may have a substantially circular cross section with a beam divergence characterized by a single divergence value. As an example, an output beam 125 with a circular cross section and a full-angle beam divergence of 2 mrad may have a beam diameter or spot size of approximately 20 cm at a distance of 100 m from lidar system 100. In particular embodiments, output beam 125 may have a substantially elliptical cross section characterized by two divergence values. As an example, output beam 125 may have a fast axis and a slow axis, where the fast-axis divergence is greater than the slow-axis divergence. As another example, output beam 125 may be an elliptical beam with a fast-axis divergence of 4 mrad and a slow-axis divergence of 2 mrad.

In particular embodiments, an output beam of light 125 emitted by light source 110 may be unpolarized or randomly polarized, may have no specific or fixed polarization (e.g., the polarization may vary with time), or may have a particular polarization (e.g., output beam 125 may be linearly polarized, elliptically polarized, or circularly polarized). As an example, light source 110 may produce light with no specific polarization or may produce light that is linearly polarized.

In particular embodiments, lidar system 100 may include one or more optical components configured to reflect, focus, filter, shape, modify, steer, or direct light within the lidar system 100 or light produced or received by the lidar system 100 (e.g., output beam 125 or input beam 135). As an example, lidar system 100 may include one or more lenses, mirrors, filters (e.g., bandpass or interference filters), beam splitters, optical splitters, polarizers, polarizing beam splitters, wave plates (e.g., half-wave or quarter-wave plates), diffractive elements, holographic elements, isolators, couplers, detectors, beam combiners, or collimators. The optical components in a lidar system 100 may be free-space optical components, fiber-coupled optical components, or a combination of free-space and fiber-coupled optical components.

In particular embodiments, lidar system 100 may include a telescope, one or more lenses, or one or more mirrors configured to expand, focus, or collimate the output beam 125 or the input beam 135 to a desired beam diameter or divergence. As an example, the lidar system 100 may include one or more lenses to focus the input beam 135 onto a photodetector of receiver 140. As another example, the lidar system 100 may include one or more flat mirrors or curved mirrors (e.g., concave, convex, or parabolic mirrors) to steer or focus the output beam 125 or the input beam 135. For example, the lidar system 100 may include an off-axis parabolic mirror to focus the input beam 135 onto a photodetector of receiver 140. As illustrated in FIG. 1, the lidar system 100 may include mirror 115 (which may be a metallic or dielectric mirror), and mirror 115 may be configured so that light beam 125 passes through the mirror 115 or passes along an edge or side of the mirror 115 and input beam 135 is reflected toward the receiver 140. As an example, mirror 115 (which may be referred to as an overlap mirror, superposition mirror, or beam-combiner mirror) may include a hole, slot, or aperture which output light beam 125 passes through. As another example, rather than passing through the mirror 115, the output beam 125 may be directed to pass alongside the mirror 115 with a gap (e.g., a gap of width approximately 0.1 mm, 0.5 mm, 1 mm, 2 mm, 5 mm, or 10 mm) between the output beam 125 and an edge of the mirror 115.

In particular embodiments, mirror 115 may provide for output beam 125 and input beam 135 to be substantially coaxial so that the two beams travel along approximately the same optical path (albeit in opposite directions). The input and output beams being substantially coaxial may refer to the beams being at least partially overlapped or sharing a common propagation axis so that input beam 135 and output beam 125 travel along substantially the same optical path (albeit in opposite directions). As an example, output beam 125 and input beam 135 may be parallel to each other to within less than 10 mrad, 5 mrad, 2 mrad, 1 mrad, 0.5 mrad, or 0.1 mrad. As output beam 125 is scanned across a field of regard, the input beam 135 may follow along with the output beam 125 so that the coaxial relationship between the two beams is maintained.

In particular embodiments, lidar system 100 may include a scanner 120 configured to scan an output beam 125 across a field of regard of the lidar system 100. As an example, scanner 120 may include one or more scanning mirrors configured to pivot, rotate, oscillate, or move in an angular manner about one or more rotation axes. The output beam 125 may be reflected by a scanning mirror, and as the scanning mirror pivots or rotates, the reflected output beam 125 may be scanned in a corresponding angular manner. As an example, a scanning mirror may be configured to periodically pivot back and forth over a 30-degree range, which results in the output beam 125 scanning back and forth across a 60-degree range (e.g., a Θ-degree rotation by a scanning mirror results in a 2Θ-degree angular scan of output beam 125).

In particular embodiments, a scanning mirror (which may be referred to as a scan mirror) may be attached to or mechanically driven by a scanner actuator or mechanism which pivots or rotates the mirror over a particular angular range (e.g., over a 5° angular range, 30° angular range, 60° angular range, 120° angular range, 360° angular range, or any other suitable angular range). A scanner actuator or mechanism configured to pivot or rotate a mirror may include a galvanometer scanner, a resonant scanner, a piezoelectric actuator, a voice coil motor, an electric motor (e.g., a DC motor, a brushless DC motor, a synchronous electric motor, or a stepper motor), a microelectromechanical systems (MEMS) device, or any other suitable actuator or mechanism. As an example, a scanner 120 may include a scanning mirror attached to a galvanometer scanner configured to pivot back and forth over a 1° to 30° angular range. As another example, a scanner 120 may include a scanning mirror that is attached to or is part of a MEMS device configured to scan over a 1° to 30° angular range. As another example, a scanner 120 may include a polygon mirror configured to rotate continuously in the same direction (e.g., rather than pivoting back and forth, the polygon mirror continuously rotates 360 degrees in a clockwise or counterclockwise direction). The polygon mirror may be coupled or attached to a synchronous motor configured to rotate the polygon mirror at a substantially fixed rotational frequency (e.g., a rotational frequency of approximately 1 Hz, 10 Hz, 50 Hz, 100 Hz, 500 Hz, or 1,000 Hz).

In particular embodiments, scanner 120 may be configured to scan the output beam 125 (which may include at least a portion of the light emitted by light source 110) across a field of regard of the lidar system 100. A field of regard (FOR) of a lidar system 100 may refer to an area, region, or angular range over which the lidar system 100 may be configured to scan or capture distance information. As an example, a lidar system 100 with an output beam 125 with a 30-degree scanning range may be referred to as having a 30-degree angular field of regard. As another example, a lidar system 100 with a scanning mirror that rotates over a 30-degree range may produce an output beam 125 that scans across a 60-degree range (e.g., a 60-degree FOR). In particular embodiments, lidar system 100 may have a FOR of approximately 10°, 20°, 40°, 60°, 120°, 360°, or any other suitable FOR.

In particular embodiments, scanner 120 may be configured to scan the output beam 125 horizontally and vertically, and lidar system 100 may have a particular FOR along the horizontal direction and another particular FOR along the vertical direction. As an example, lidar system 100 may have a horizontal FOR of 10° to 120° and a vertical FOR of 2° to 45°. In particular embodiments, scanner 120 may include a first scan mirror and a second scan mirror, where the first scan mirror directs the output beam 125 toward the second scan mirror, and the second scan mirror directs the output beam 125 downrange from the lidar system 100. As an example, the first scan mirror may scan the output beam 125 along a first direction, and the second scan mirror may scan the output beam 125 along a second direction that is different from the first direction (e.g., the second direction may be substantially orthogonal to the first direction). As another example, the first scan mirror may scan the output beam 125 along a substantially horizontal direction, and the second scan mirror may scan the output beam 125 along a substantially vertical direction (or vice versa). As another example, the first and second scan mirrors may each be driven by galvanometer scanners. As another example, the first or second scan mirror may include a polygon mirror driven by an electric motor. In particular embodiments, scanner 120 may be referred to as a beam scanner, optical scanner, or laser scanner.

In particular embodiments, one or more scanning mirrors may be communicatively coupled to controller 150 which may control the scanning mirror(s) so as to guide the output beam 125 in a desired direction downrange or along a desired scan pattern. In particular embodiments, a scan pattern may refer to a pattern or path along which the output beam 125 is directed. As an example, scanner 120 may include two scanning mirrors configured to scan the output beam 125 across a 60° horizontal FOR and a 20° vertical FOR. The two scanner mirrors may be controlled to follow a scan path that substantially covers the 60°×20° FOR. As an example, the scan path may result in a point cloud with pixels that substantially cover the 60°×20° FOR. The pixels may be approximately evenly distributed across the 60°×20° FOR. Alternatively, the pixels may have a particular nonuniform distribution (e.g., the pixels may be distributed across all or a portion of the 60°×20° FOR, and the pixels may have a higher density in one or more particular regions of the 60°×20° FOR).

In particular embodiments, a lidar system 100 may include a scanner 120 with a solid-state scanning device. A solid-state scanning device may refer to a scanner 120 that scans an output beam 125 without the use of moving parts (e.g., without the use of a mechanical scanner, such as a mirror that rotates or pivots). For example, a solid-state scanner 120 may include one or more of the following: an optical phased array scanning device; a liquid-crystal scanning device; or a liquid lens scanning device. A solid-state scanner 120 may be an electrically addressable device that scans an output beam 125 along one axis (e.g., horizontally) or along two axes (e.g., horizontally and vertically). In particular embodiments, a scanner 120 may include a solid-state scanner and a mechanical scanner. For example, a scanner 120 may include an optical phased array scanner configured to scan an output beam 125 in one direction and a galvanometer scanner that scans the output beam 125 in an orthogonal direction. The optical phased array scanner may scan the output beam relatively rapidly in a horizontal direction across the field of regard (e.g., at a scan rate of 50 to 1,000 scan lines per second), and the galvanometer may pivot a mirror at a rate of 1-30 Hz to scan the output beam 125 vertically.

In particular embodiments, a lidar system 100 may include a light source 110 configured to emit pulses of light and a scanner 120 configured to scan at least a portion of the emitted pulses of light across a field of regard of the lidar system 100. One or more of the emitted pulses of light may be scattered by a target 130 located downrange from the lidar system 100, and a receiver 140 may detect at least a portion of the pulses of light scattered by the target 130. A receiver 140 may be referred to as a photoreceiver, optical receiver, optical sensor, detector, photodetector, or optical detector. In particular embodiments, lidar system 100 may include a receiver 140 that receives or detects at least a portion of input beam 135 and produces an electrical signal that corresponds to input beam 135. As an example, if input beam 135 includes an optical pulse, then receiver 140 may produce an electrical current or voltage pulse that corresponds to the optical pulse detected by receiver 140. As another example, receiver 140 may include one or more avalanche photodiodes (APDs) or one or more single-photon avalanche diodes (SPADs). As another example, receiver 140 may include one or more PN photodiodes (e.g., a photodiode structure formed by a p-type semiconductor and an n-type semiconductor, where the PN acronym refers to the structure having p-doped and n-doped regions) or one or more PIN photodiodes (e.g., a photodiode structure formed by an undoped intrinsic semiconductor region located between p-type and n-type regions, where the PIN acronym refers to the structure having p-doped, intrinsic, and n-doped regions). An APD, SPAD, PN photodiode, or PIN photodiode may each be referred to as a detector, photodetector, or photodiode. A detector may have an active region or an avalanche-multiplication region that includes silicon, germanium, InGaAs, InAsSb (indium arsenide antimonide), AlAsSb (aluminum arsenide antimonide), or AlInAsSb (aluminum indium arsenide antimonide). The active region may refer to an area over which a detector may receive or detect input light. An active region may have any suitable size or diameter, such as for example, a diameter of approximately 10 μm, 25 μm, 50 μm, 80 μm, 100 μm, 200 μm, 500 μm, 1 mm, 2 mm, or 5 mm.

In particular embodiments, receiver 140 may include electronic circuitry that performs signal amplification, sampling, filtering, signal conditioning, analog-to-digital conversion, time-to-digital conversion, pulse detection, threshold detection, rising-edge detection, or falling-edge detection. As an example, receiver 140 may include a transimpedance amplifier that converts a received photocurrent (e.g., a current produced by an APD in response to a received optical signal) into a voltage signal. The voltage signal may be sent to signal-detection circuitry that produces an analog or digital output signal 145 that corresponds to one or more optical characteristics (e.g., rising edge, falling edge, amplitude, duration, or energy) of a received optical pulse. As an example, the signal-detection circuitry may perform a time-to-digital conversion to produce a digital output signal 145. The electrical output signal 145 may be sent to controller 150 for processing or analysis (e.g., to determine a time-of-flight value corresponding to a received optical pulse).

In particular embodiments, a controller 150 (which may include or may be referred to as a processor, an FPGA, an ASIC, a computer, or a computing system) may be located within a lidar system 100 or outside of a lidar system 100. Alternatively, one or more parts of a controller 150 may be located within a lidar system 100, and one or more other parts of a controller 150 may be located outside a lidar system 100. In particular embodiments, one or more parts of a controller 150 may be located within a receiver 140 of a lidar system 100, and one or more other parts of a controller 150 may be located in other parts of the lidar system 100. For example, a receiver 140 may include an FPGA or ASIC configured to process an output electrical signal from the receiver 140, and the processed signal may be sent to a computing system located elsewhere within the lidar system 100 or outside the lidar system 100. In particular embodiments, a controller 150 may include any suitable arrangement or combination of logic circuitry, analog circuitry, or digital circuitry.

In particular embodiments, controller 150 may be electrically coupled or communicatively coupled to light source 110, scanner 120, or receiver 140. As an example, controller 150 may receive electrical trigger pulses or edges from light source 110, where each pulse or edge corresponds to the emission of an optical pulse by light source 110. As another example, controller 150 may provide instructions, a control signal, or a trigger signal to light source 110 indicating when light source 110 should produce optical pulses. Controller 150 may send an electrical trigger signal that includes electrical pulses, where each electrical pulse results in the emission of an optical pulse by light source 110. In particular embodiments, the frequency, period, duration, pulse energy, peak power, average power, or wavelength of the optical pulses produced by light source 110 may be adjusted based on instructions, a control signal, or trigger pulses provided by controller 150. In particular embodiments, controller 150 may be coupled to light source 110 and receiver 140, and controller 150 may determine a time-of-flight value for an optical pulse based on timing information associated with when the pulse was emitted by light source 110 and when a portion of the pulse (e.g., input beam 135) was detected or received by receiver 140. In particular embodiments, controller 150 may include circuitry that performs signal amplification, sampling, filtering, signal conditioning, analog-to-digital conversion, time-to-digital conversion, pulse detection, threshold detection, rising-edge detection, or falling-edge detection.

In particular embodiments, lidar system 100 may include one or more processors (e.g., a controller 150) configured to determine a distance D from the lidar system 100 to a target 130 based at least in part on a round-trip time of flight for an emitted pulse of light to travel from the lidar system 100 to the target 130 and back to the lidar system 100. The target 130 may be at least partially contained within a field of regard of the lidar system 100 and located a distance D from the lidar system 100 that is less than or equal to an operating range (R_{OP}) of the lidar system 100. In particular embodiments, an operating range (which may be referred to as an operating distance) of a lidar system 100 may refer to a distance over which the lidar system 100 is configured to sense or identify targets 130 located within a field of regard of the lidar system 100. The operating range of lidar system 100 may be any suitable distance, such as for example, 25 m, 50 m, 100 m, 200 m, 250 m, 500 m, or 1 km. As an example, a lidar system 100 with a 200-m operating range may be configured to sense or identify various targets 130 located up to 200 m away from the lidar system 100. The operating range R_{OP} of a lidar system 100 may be related to the time τ between the emission of successive optical signals by the expression R_{OP}=c·τ/2. For a lidar system 100 with a 200-m operating range (R_{OP}=200 m), the time τ between successive pulses (which may be referred to as a pulse period, a pulse repetition interval (PRI), or a time period between pulses) is approximately 2·R_{OP}/c≅1.33 μs. The pulse period τ may also correspond to the time of flight for a pulse to travel to and from a target 130 located a distance R_{OP} from the lidar system 100. Additionally, the pulse period τ may be related to the pulse repetition frequency (PRF) by the expression τ=1/PRF. For example, a pulse period of 1.33 μs corresponds to a PRF of approximately 752 kHz.

In particular embodiments, a lidar system 100 may be used to determine the distance to one or more downrange targets 130. By scanning the lidar system 100 across a field of regard, the system may be used to map the distance to a number of points within the field of regard. Each of these depth-mapped points may be referred to as a pixel or a voxel. A collection of pixels captured in succession (which may be referred to as a depth map, a point cloud, or a frame) may be rendered as an image or may be analyzed to identify or detect objects or to determine a shape or distance of objects within the FOR. As an example, a point cloud may cover a field of regard that extends 60° horizontally and 15° vertically, and the point cloud may include a frame of 100-2000 pixels in the horizontal direction by 4-400 pixels in the vertical direction.

In particular embodiments, lidar system 100 may be configured to repeatedly capture or generate point clouds of a field of regard at any suitable frame rate between approximately 0.1 frames per second (FPS) and approximately 1,000 FPS. As an example, lidar system 100 may generate point clouds at a frame rate of approximately 0.1 FPS, 0.5 FPS, 1 FPS, 2 FPS, 5 FPS, 10 FPS, 20 FPS, 100 FPS, 500 FPS, or 1,000 FPS. As another example, lidar system 100 may be configured to produce optical pulses at a rate of 5×10⁵ pulses/second (e.g., the system may determine 500,000 pixel distances per second) and scan a frame of 1000×50 pixels (e.g., 50,000 pixels/frame), which corresponds to a point-cloud frame rate of 10 frames per second (e.g., 10 point clouds per second). In particular embodiments, a point-cloud frame rate may be substantially fixed, or a point-cloud frame rate may be dynamically adjustable. As an example, a lidar system 100 may capture one or more point clouds at a particular frame rate (e.g., 1 Hz) and then switch to capture one or more point clouds at a different frame rate (e.g., 10 Hz). A slower frame rate (e.g., 1 Hz) may be used to capture one or more high-resolution point clouds, and a faster frame rate (e.g., 10 Hz) may be used to rapidly capture multiple lower-resolution point clouds.

In particular embodiments, a lidar system 100 may be configured to sense, identify, or determine distances to one or more targets 130 within a field of regard. As an example, a lidar system 100 may determine a distance to a target 130, where all or part of the target 130 is contained within a field of regard of the lidar system 100. All or part of a target 130 being contained within a FOR of the lidar system 100 may refer to the FOR overlapping, encompassing, or enclosing at least a portion of the target 130. In particular embodiments, target 130 may include all or part of an object that is moving or stationary relative to lidar system 100. As an example, target 130 may include all or a portion of a person, vehicle, motorcycle, truck, train, bicycle, wheelchair, pedestrian, animal, road sign, traffic light, lane marking, road-surface marking, parking space, pylon, guard rail, traffic barrier, pothole, railroad crossing, obstacle in or near a road, curb, stopped vehicle on or beside a road, utility pole, house, building, trash can, mailbox, tree, any other suitable object, or any suitable combination of all or part of two or more objects. In particular embodiments, a target may be referred to as an object.

In particular embodiments, light source 110, scanner 120, and receiver 140 may be packaged together within a single housing, where a housing may refer to a box, case, or enclosure that holds or contains all or part of a lidar system 100. As an example, a lidar-system enclosure may contain a light source 110, mirror 115, scanner 120, and receiver 140 of a lidar system 100. Additionally, the lidar-system enclosure may include a controller 150. The lidar-system enclosure may also include one or more electrical connections for conveying electrical power or electrical signals to or from the enclosure. In particular embodiments, one or more components of a lidar system 100 may be located remotely from a lidar-system enclosure. As an example, all or part of light source 110 may be located remotely from a lidar-system enclosure, and pulses of light produced by the light source 110 may be conveyed to the enclosure via optical fiber. As another example, all or part of a controller 150 may be located remotely from a lidar-system enclosure.

In particular embodiments, light source 110 may include an eye-safe laser, or lidar system 100 may be classified as an eye-safe laser system or laser product. An eye-safe laser, laser system, or laser product may refer to a system that includes a laser with an emission wavelength, average power, peak power, peak intensity, pulse energy, beam size, beam divergence, exposure time, or scanned output beam such that emitted light from the system presents little or no possibility of causing damage to a person's eyes. As an example, light source 110 or lidar system 100 may be classified as a Class 1 laser product (as specified by the 60825-1:2014 standard of the International Electrotechnical Commission (IEC)) or a Class I laser product (as specified by Title 21, Section 1040.10 of the United States Code of Federal Regulations (CFR)) that is safe under all conditions of normal use. In particular embodiments, lidar system 100 may be an eye-safe laser product (e.g., with a Class 1 or Class I classification) configured to operate at any suitable wavelength between approximately 900 nm and approximately 2100 nm. As an example, lidar system 100 may include a laser with an operating wavelength between approximately 1200 nm and approximately 1400 nm or between approximately 1400 nm and approximately 1600 nm, and the laser or the lidar system 100 may be operated in an eye-safe manner. As another example, lidar system 100 may be an eye-safe laser product that includes a scanned laser with an operating wavelength between approximately 900 nm and approximately 1700 nm. As another example, lidar system 100 may be a Class 1 or Class I laser product that includes a laser diode, fiber laser, or solid-state laser with an operating wavelength between approximately 1200 nm and approximately 1600 nm. As another example, lidar system 100 may have operating wavelengths between approximately 1500 nm and approximately 1550 nm.

In particular embodiments, one or more lidar systems 100 may be integrated into a vehicle. As an example, multiple lidar systems 100 may be integrated into a car to provide a complete 360-degree horizontal FOR around the car. As another example, 2-10 lidar systems 100, each system having a 45-degree to 180-degree horizontal FOR, may be combined together to form a sensing system that provides a point cloud covering a 360-degree horizontal FOR. The lidar systems 100 may be oriented so that adjacent FORs have an amount of spatial or angular overlap to allow data from the multiple lidar systems 100 to be combined or stitched together to form a single or continuous 360-degree point cloud. As an example, the FOR of each lidar system 100 may have approximately 1-30 degrees of overlap with an adjacent FOR. In particular embodiments, a vehicle may refer to a mobile machine configured to transport people or cargo. For example, a vehicle may include, may take the form of, or may be referred to as a car, automobile, motor vehicle, truck, bus, van, trailer, off-road vehicle, farm vehicle, lawn mower, construction equipment, forklift, robot, golf cart, motorhome, taxi, motorcycle, scooter, bicycle, skateboard, train, snowmobile, watercraft (e.g., a ship or boat), aircraft (e.g., a fixed-wing aircraft, helicopter, or dirigible), unmanned aerial vehicle (e.g., drone), or spacecraft. In particular embodiments, a vehicle may include an internal combustion engine or an electric motor that provides propulsion for the vehicle.

In particular embodiments, one or more lidar systems 100 may be included in a vehicle as part of an advanced driver assistance system (ADAS) to assist a driver of the vehicle in operating the vehicle. For example, a lidar system 100 may be part of an ADAS that provides information (e.g., about the surrounding environment) or feedback to a driver (e.g., to alert the driver to potential problems or hazards) or that automatically takes control of part of a vehicle (e.g., a braking system or a steering system) to avoid collisions or accidents. A lidar system 100 may be part of a vehicle ADAS that provides adaptive cruise control, automated braking, automated parking, collision avoidance, alerts the driver to hazards or other vehicles, maintains the vehicle in the correct lane, or provides a warning if an object or another vehicle is in a blind spot.

In particular embodiments, one or more lidar systems 100 may be integrated into a vehicle as part of an autonomous-vehicle driving system. As an example, a lidar system 100 may provide information about the surrounding environment to a driving system of an autonomous vehicle. An autonomous-vehicle driving system may be configured to guide the autonomous vehicle through an environment surrounding the vehicle and toward a destination. An autonomous-vehicle driving system may include one or more computing systems that receive information from a lidar system 100 about the surrounding environment, analyze the received information, and provide control signals to the vehicle's driving systems (e.g., steering mechanism, accelerator, brakes, lights, or turn signals). As an example, a lidar system 100 integrated into an autonomous vehicle may provide an autonomous-vehicle driving system with a point cloud every 0.1 seconds (e.g., the point cloud has a 10 Hz update rate, representing 10 frames per second). The autonomous-vehicle driving system may analyze the received point clouds to sense or identify targets 130 and their respective locations, distances, or speeds, and the autonomous-vehicle driving system may update control signals based on this information. As an example, if lidar system 100 detects a vehicle ahead that is slowing down or stopping, the autonomous-vehicle driving system may send instructions to release the accelerator and apply the brakes.

In particular embodiments, an autonomous vehicle may be referred to as an autonomous car, driverless car, self-driving car, robotic car, or unmanned vehicle. In particular embodiments, an autonomous vehicle may refer to a vehicle configured to sense its environment and navigate or drive with little or no human input. As an example, an autonomous vehicle may be configured to drive to any suitable location and control or perform all safety-critical functions (e.g., driving, steering, braking, parking) for the entire trip, with the driver not expected to control the vehicle at any time. As another example, an autonomous vehicle may allow a driver to safely turn their attention away from driving tasks in particular environments (e.g., on freeways), or an autonomous vehicle may provide control of a vehicle in all but a few environments, requiring little or no input or attention from the driver.

In particular embodiments, an autonomous vehicle may be configured to drive with a driver present in the vehicle, or an autonomous vehicle may be configured to operate the vehicle with no driver present. As an example, an autonomous vehicle may include a driver's seat with associated controls (e.g., steering wheel, accelerator pedal, and brake pedal), and the vehicle may be configured to drive with no one seated in the driver's seat or with little or no input from a person seated in the driver's seat. As another example, an autonomous vehicle may not include any driver's seat or associated driver's controls, and the vehicle may perform substantially all driving functions (e.g., driving, steering, braking, parking, and navigating) without human input. As another example, an autonomous vehicle may be configured to operate without a driver (e.g., the vehicle may be configured to transport human passengers or cargo without a driver present in the vehicle). As another example, an autonomous vehicle may be configured to operate without any human passengers (e.g., the vehicle may be configured for transportation of cargo without having any human passengers onboard the vehicle).

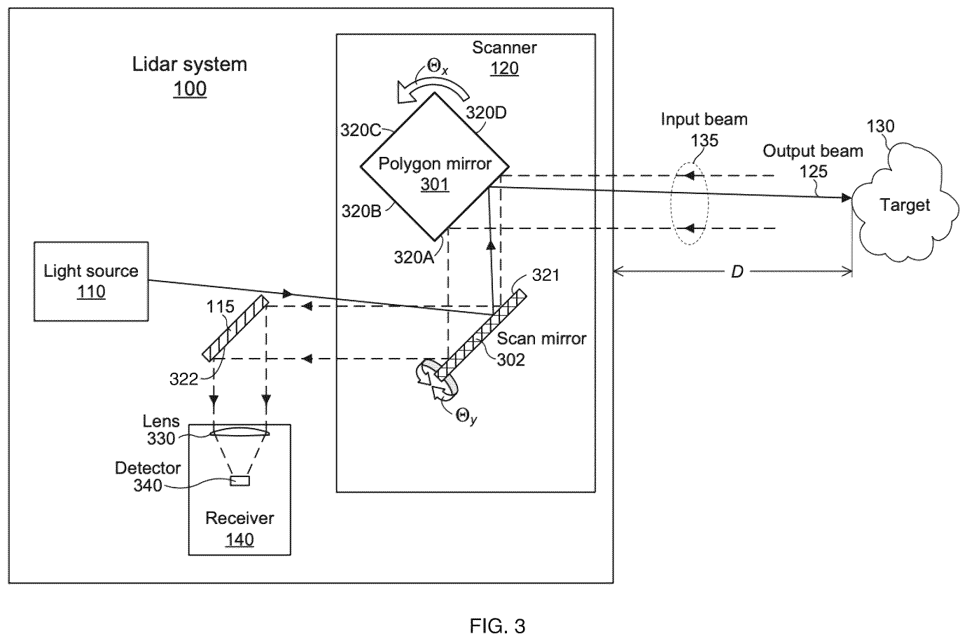

In particular embodiments, an optical signal (which may be referred to as a light signal, a light waveform, an optical waveform, an output beam, or emitted light) may include pulses of light, CW light, amplitude-modulated light, frequency-modulated (FM) light, or any suitable combination thereof. For example, a lidar system 100 as described or illustrated herein may be a pulsed lidar system and may include a light source 110 that produces pulses of light. The pulsed lidar system 100 may include a light source 110 that emits an output beam 125 with optical pulses having one or more of the following optical characteristics: a wavelength between 900 nm and 2100 nm (e.g., a wavelength of approximately 905 nm, a wavelength between 1500 nm and 1510 nm, a wavelength between 1400 nm and 1600 nm, or any other suitable operating wavelength between 900 nm and 2100 nm); a pulse energy between 0.01 μJ and 100 μJ; a pulse repetition frequency between 80 kHz and 10 MHz; and a pulse duration between 1 ns and 100 ns. For example, the light source 110 in FIG. 1 or FIG. 3 may emit an output beam 125 with optical pulses having a wavelength of approximately 1550 nm, a pulse energy of approximately 0.5 μJ, a pulse repetition frequency of approximately 600 kHz, and a pulse duration of approximately 5 ns. Although this disclosure describes or illustrates example embodiments of lidar systems 100 or light sources 110 that produce optical signals that include pulses of light, the embodiments described or illustrated herein may also be applied, where appropriate, to other types of optical signals, including continuous-wave (CW) light, amplitude-modulated optical signals, or frequency-modulated optical signals. For example, a lidar system 100 may be configured to operate as a frequency-modulated continuous-wave (FMCW) lidar system and may include a light source 110 that produces CW light or a frequency-modulated optical signal.

In particular embodiments, a lidar system 100 may be an FMCW lidar system where the emitted light from the light source 110 (e.g., output beam 125 in FIG. 1 or FIG. 3) includes frequency-modulated light. A pulsed lidar system is a type of lidar system 100 in which the light source 110 emits pulses of light, and the distance to a remote target 130 is determined based on the round-trip time-of-flight for a pulse of light to travel to the target 130 and back. Another type of lidar system 100 is a frequency-modulated lidar system, which may be referred to as a frequency-modulated continuous-wave (FMCW) lidar system. An FMCW lidar system uses frequency-modulated light to determine the distance to a remote target 130 based on a frequency of received light (which includes emitted light scattered by the remote target) relative to a frequency of local-oscillator (LO) light. A round-trip time for the emitted light to travel to a target 130 and back to the lidar system may correspond to a frequency difference between the received scattered light and the LO light. A larger frequency difference may correspond to a longer round-trip time and a greater distance to the target 130.

A light source 110 for an FMCW lidar system may include at least one instance of (i) a direct-emitter laser diode, (ii) a seed laser diode followed by an SOA, (iii) a seed laser diode followed by a fiber-optic amplifier, or (iv) a seed laser diode followed by an SOA and then a fiber-optic amplifier. A seed laser diode or a direct-emitter laser diode may be operated in a CW manner (e.g., by driving the laser diode with a substantially constant DC current), and a frequency modulation may be provided by an external modulator (e.g., an electro-optic phase modulator may apply a frequency modulation to seed-laser light). Alternatively, a frequency modulation may be produced by applying a current modulation to a seed laser diode or a direct-emitter laser diode. The current modulation (which may be provided along with a DC bias current) may produce a corresponding refractive-index modulation in the laser diode, which results in a frequency modulation of the light emitted by the laser diode. The current-modulation component (and the corresponding frequency modulation) may have any suitable frequency or shape (e.g., piecewise linear, sinusoidal, triangle-wave, or sawtooth). For example, the current-modulation component (and the resulting frequency modulation of the emitted light) may increase or decrease monotonically over a particular time interval. As another example, the current-modulation component may include a triangle or sawtooth wave with an electrical current that increases or decreases linearly over a particular time interval, and the light emitted by the laser diode may include a corresponding frequency modulation in which the optical frequency increases or decreases approximately linearly over the particular time interval. For example, a light source 110 that emits light with a linear frequency change of 200 MHz over a 2-μs time interval may be referred to as having a frequency modulation m of 10¹⁴ Hz/s (or, 100 MHz/μs).

In addition to producing frequency-modulated emitted light, a light source 110 may also produce frequency-modulated local-oscillator (LO) light. The LO light may be coherent with the emitted light, and the frequency modulation of the LO light may match that of the emitted light. The LO light may be produced by splitting off a portion of the emitted light prior to the emitted light exiting the lidar system. Alternatively, the LO light may be produced by a seed laser diode or a direct-emitter laser diode that is part of the light source 110. For example, the LO light may be emitted from the back facet of a seed laser diode or a direct-emitter laser diode, or the LO light may be split off from the seed light emitted from the front facet of a seed laser diode. The received light (e.g., emitted light that is scattered by a target 130) and the LO light may each be frequency modulated, with a frequency difference or offset that corresponds to the distance to the target 130. For a linearly chirped light source (e.g., a frequency modulation that produces a linear change in frequency with time), the larger the frequency difference is between the received light and the LO light, the farther away the target 130 is located.

A frequency difference between received light and LO light may be determined by mixing the received light with the LO light (e.g., by coupling the two beams onto a detector 340 of a receiver 140 so they are coherently mixed together at the detector) and determining the resulting beat frequency. For example, a photocurrent signal produced by an APD may include a beat signal resulting from the coherent mixing of the received light and the LO light, and a frequency of the beat signal may correspond to the frequency difference between the received light and the LO light. The photocurrent signal from an APD (or a voltage signal that corresponds to the photocurrent signal) may be analyzed using a frequency-analysis technique (e.g., a fast Fourier transform (FFT) technique) to determine the frequency of the beat signal. If a linear frequency modulation m (e.g., in units of Hz/s) is applied to a CW laser, then the round-trip time T may be related to the frequency difference Δf between the received scattered light and the LO light by the expression T=Δf/m. Additionally, the distance D from the target 130 to the lidar system 100 may be expressed as D=(Δf/m)·c/2, where c is the speed of light. For example, for a light source 110 with a linear frequency modulation of 10¹⁴ Hz/s, if a frequency difference (between the received scattered light and the LO light) of 33 MHz is measured, then this corresponds to a round-trip time of approximately 330 ns and a distance to the target of approximately 50 meters. As another example, a frequency difference of 133 MHz corresponds to a round-trip time of approximately 1.33 μs and a distance to the target of approximately 200 meters.

In particular embodiments, a receiver or processor of an FMCW lidar system may determine a frequency difference between received scattered light and LO light, and a distance to a target 130 may be determined based on the frequency difference. The frequency difference Δf between received scattered light and LO light corresponds to the round-trip time T (e.g., through the relationship T=Δf/m), and determining the frequency difference may correspond to or may be referred to as determining the round-trip time. For example, a receiver of a FMCW lidar system may determine a frequency difference between received scattered light and LO light, and based on the determined frequency difference, a processor may determine a distance to the target.

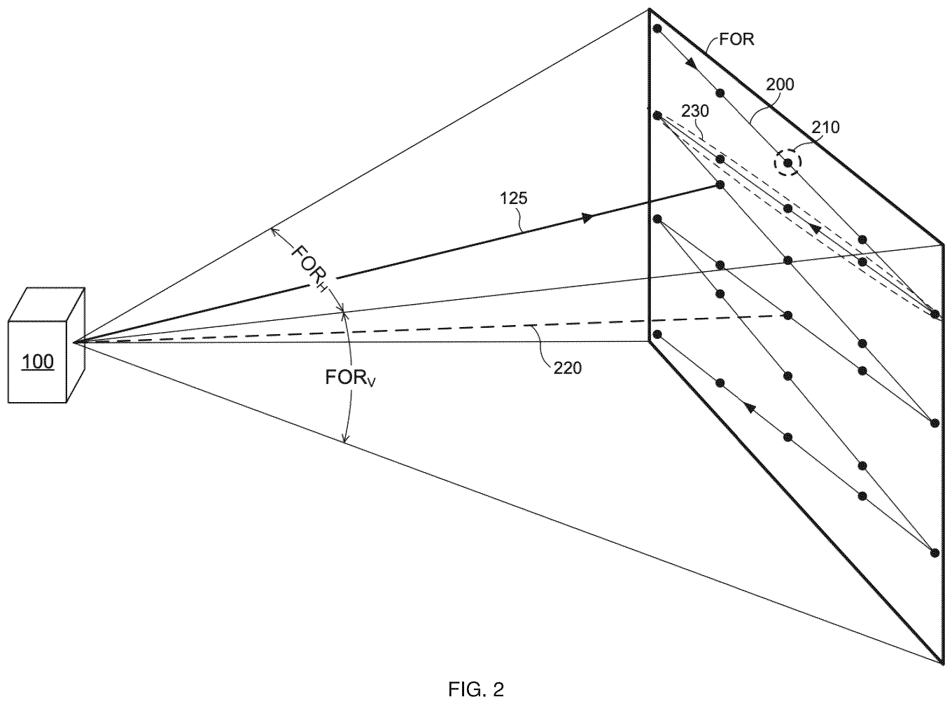

FIG. 2 illustrates an example scan pattern 200 produced by a lidar system 100. A scanner 120 of the lidar system 100 may scan the output beam 125 (which may include multiple emitted optical signals) along a scan pattern 200 that is contained within a field of regard (FOR) of the lidar system 100. A scan pattern 200 (which may be referred to as an optical scan pattern, optical scan path, scan path, or scan) may represent a path or course followed by output beam 125 as it is scanned across all or part of a FOR. Each traversal of a scan pattern 200 may correspond to the capture of a single frame or a single point cloud. In particular embodiments, a lidar system 100 may be configured to scan output optical beam 125 along one or more particular scan patterns 200. In particular embodiments, a scan pattern 200 may scan across any suitable field of regard (FOR) having any suitable horizontal FOR (FOR_{H}) and any suitable vertical FOR (FOR_{V}). For example, a scan pattern 200 may have a field of regard represented by angular dimensions (e.g., FOR_{H}×FOR_{V}) 40°×30°, 90°×40°, or 60°×15°. As another example, a scan pattern 200 may have a FOR_{H} greater than or equal to 10°, 25°, 30°, 40°, 60°, 90°, or 120°. As another example, a scan pattern 200 may have a FOR_{V} greater than or equal to 2°, 5°, 10°, 15°, 20°, 30°, or 45°.

In the example of FIG. 2, reference line 220 represents a center of the field of regard of scan pattern 200. In particular embodiments, reference line 220 may have any suitable orientation, such as for example, a horizontal angle of 0° (e.g., reference line 220 may be oriented straight ahead) and a vertical angle of 0° (e.g., reference line 220 may have an inclination of 0°), or reference line 220 may have a nonzero horizontal angle or a nonzero inclination (e.g., a vertical angle of +10° or −10°. In FIG. 2, if the scan pattern 200 has a 60°×15° field of regard, then scan pattern 200 covers a ±30° horizontal range with respect to reference line 220 and a ±7.5° vertical range with respect to reference line 220. Additionally, optical beam 125 in FIG. 2 has an orientation of approximately −15° horizontal and +3° vertical with respect to reference line 220. Optical beam 125 may be referred to as having an azimuth of −15° and an altitude of +3° relative to reference line 220. In particular embodiments, an azimuth (which may be referred to as an azimuth angle) may represent a horizontal angle with respect to reference line 220, and an altitude (which may be referred to as an altitude angle, elevation, or elevation angle) may represent a vertical angle with respect to reference line 220.

In particular embodiments, a scan pattern 200 may include multiple pixels 210, and each pixel 210 may be associated with one or more laser pulses or one or more distance measurements. Additionally, a scan pattern 200 may include multiple scan lines 230, where each scan line represents one scan across at least part of a field of regard, and each scan line 230 may include multiple pixels 210. In FIG. 2, scan line 230 includes five pixels 210 and corresponds to an approximately horizontal scan across the FOR from right to left, as viewed from the lidar system 100. In particular embodiments, a cycle of scan pattern 200 may include a total of Pₓ×P_{y} pixels 210 (e.g., a two-dimensional distribution of Pₓ by P_{y} pixels). As an example, scan pattern 200 may include a distribution with dimensions of approximately 100-2,000 pixels 210 along a horizontal direction and approximately 4-400 pixels 210 along a vertical direction. As another example, scan pattern 200 may include a distribution of 1,000 pixels 210 along the horizontal direction by 64 pixels 210 along the vertical direction (e.g., the frame size is 1000×64 pixels) for a total of 64,000 pixels per cycle of scan pattern 200. In particular embodiments, the number of pixels 210 along a horizontal direction may be referred to as a horizontal resolution of scan pattern 200, and the number of pixels 210 along a vertical direction may be referred to as a vertical resolution. As an example, scan pattern 200 may have a horizontal resolution of greater than or equal to 100 pixels 210 and a vertical resolution of greater than or equal to 4 pixels 210. As another example, scan pattern 200 may have a horizontal resolution of 100-2,000 pixels 210 and a vertical resolution of 4-400 pixels 210.

In particular embodiments, each pixel 210 may be associated with a distance (e.g., a distance to a portion of a target 130 from which an associated laser pulse was scattered) or one or more angular values. As an example, a pixel 210 may be associated with a distance value and two angular values (e.g., an azimuth and altitude) that represent the angular location of the pixel 210 with respect to the lidar system 100. A distance to a portion of target 130 may be determined based at least in part on a time-of-flight measurement for a corresponding pulse. An angular value (e.g., an azimuth or altitude) may correspond to an angle (e.g., relative to reference line 220) of output beam 125 (e.g., when a corresponding pulse is emitted from lidar system 100) or an angle of input beam 135 (e.g., when an input signal is received by lidar system 100). In particular embodiments, an angular value may be determined based at least in part on a position of a component of scanner 120. As an example, an azimuth or altitude value associated with a pixel 210 may be determined from an angular position of one or more corresponding scanning mirrors of scanner 120.

FIG. 3 illustrates an example lidar system 100 with an example rotating polygon mirror 301. In particular embodiments, a scanner 120 may include a polygon mirror 301 configured to scan output beam 125 along a particular direction. In the example of FIG. 3, scanner 120 includes two scanning mirrors: (1) a polygon mirror 301 that rotates along the Θₓ direction and (2) a scanning mirror 302 that oscillates back and forth along the Θ_{y} direction. The output beam 125 from light source 110, which passes alongside mirror 115, is reflected by reflecting surface 321 of scan mirror 302 and is then reflected by a reflecting surface (e.g., surface 320A, 320B, 320C, or 320D) of polygon mirror 301. Scattered light from a target 130 returns to the lidar system 100 as input beam 135. The input beam 135 reflects from polygon mirror 301, scan mirror 302, and mirror 115, which directs input beam 135 through focusing lens 330 and to the detector 340 of receiver 140. As shown in FIG. 3, scan mirror 302 includes reflecting surface 321 and mirror 115 includes reflecting surface 322. The detector 340 may be a PN photodiode, a PIN photodiode, an APD, an SPAD, or any other suitable detector. A reflecting surface 320 (which may be referred to as a reflective surface) may include a reflective metallic coating (e.g., gold, silver, or aluminum) or a reflective dielectric coating, and the reflecting surface 320 may have any suitable reflectivity R at an operating wavelength of the light source 110 (e.g., R greater than or equal to 70%, 80%, 90%, 95%, 98%, or 99%).

In particular embodiments, a polygon mirror 301 may be configured to rotate along a Θₓ or Θ_{y} direction and scan output beam 125 along a substantially horizontal or vertical direction, respectively. A rotation along a Θₓ direction may refer to a rotational motion of mirror 301 that results in output beam 125 scanning along a substantially horizontal direction. Similarly, a rotation along a Θ_{y} direction may refer to a rotational motion that results in output beam 125 scanning along a substantially vertical direction. In FIG. 3, mirror 301 is a polygon mirror that rotates along the Θₓ direction and scans output beam 125 along a substantially horizontal direction, and mirror 302 pivots along the Θ_{y} direction and scans output beam 125 along a substantially vertical direction. In particular embodiments, a polygon mirror 301 may be configured to scan output beam 125 along any suitable direction. As an example, a polygon mirror 301 may scan output beam 125 at any suitable angle with respect to a horizontal or vertical direction, such as for example, at an angle of approximately 0°, 10°, 20°, 30°, 45°, 60°, 70°, 80°, or 90° with respect to a horizontal or vertical direction. Additionally, scan mirror 302 may scan the output beam 125 along any suitable direction that is different from the scan direction of the polygon mirror 301. For example, scan mirror 302 may scan the output beam 125 along a direction that is approximately orthogonal to the scan direction of the polygon mirror 301.

In particular embodiments, a polygon mirror 301 may refer to a multi-sided object having reflective surfaces 320 on two or more of its sides or faces. As an example, a polygon mirror may include any suitable number of reflective faces (e.g., 2, 3, 4, 5, 6, 7, 8, or 10 faces), where each face includes a reflective surface 320. A polygon mirror 301 may have a cross-sectional shape of any suitable polygon, such as for example, a triangle (with three reflecting surfaces 320), square (with four reflecting surfaces 320), pentagon (with five reflecting surfaces 320), hexagon (with six reflecting surfaces 320), heptagon (with seven reflecting surfaces 320), or octagon (with eight reflecting surfaces 320). In FIG. 3, the polygon mirror 301 has a substantially square cross-sectional shape and four reflecting surfaces (320A, 320B, 320C, and 320D). The polygon mirror 301 in FIG. 3 may be referred to as a square mirror, a cube mirror, or a four-sided polygon mirror. In FIG. 3, the polygon mirror 301 may have a shape similar to a cube, cuboid, or rectangular prism. Additionally, the polygon mirror 301 may have a total of six sides, where four of the sides include faces with reflective surfaces (320A, 320B, 320C, and 320D).

In particular embodiments, a polygon mirror 301 may be continuously rotated in a clockwise or counter-clockwise rotation direction about a rotation axis of the polygon mirror 301. The rotation axis may correspond to a line that is perpendicular to the plane of rotation of the polygon mirror 301 and that passes through the center of mass of the polygon mirror 301. In FIG. 3, the polygon mirror 301 rotates in the plane of the drawing, and the rotation axis of the polygon mirror 301 is perpendicular to the plane of the drawing. An electric motor may be configured to rotate a polygon mirror 301 at a substantially fixed frequency (e.g., a rotational frequency of approximately 1 Hz (or 1 revolution per second), 10 Hz, 50 Hz, 100 Hz, 500 Hz, or 1,000 Hz). As an example, a polygon mirror 301 may be mechanically coupled to an electric motor (e.g., a synchronous electric motor) which is configured to spin the polygon mirror 301 at a rotational speed of approximately 160 Hz (or, 9600 revolutions per minute (RPM)).

In particular embodiments, output beam 125 may be reflected sequentially from the reflective surfaces 320A, 320B, 320C, and 320D as the polygon mirror 301 is rotated. This results in the output beam 125 being scanned along a particular scan axis (e.g., a horizontal or vertical scan axis) to produce a sequence of scan lines, where each scan line corresponds to a reflection of the output beam 125 from one of the reflective surfaces of the polygon mirror 301. In FIG. 3, the output beam 125 reflects off of reflective surface 320A to produce one scan line. Then, as the polygon mirror 301 rotates, the output beam 125 reflects off of reflective surfaces 320B, 320C, and 320D to produce a second, third, and fourth respective scan line. In particular embodiments, a lidar system 100 may be configured so that the output beam 125 is first reflected from polygon mirror 301 and then from scan mirror 302 (or vice versa). As an example, an output beam 125 from light source 110 may first be directed to polygon mirror 301, where it is reflected by a reflective surface of the polygon mirror 301, and then the output beam 125 may be directed to scan mirror 302, where it is reflected by reflective surface 321 of the scan mirror 302. In the example of FIG. 3, the output beam 125 is reflected from the polygon mirror 301 and the scan mirror 302 in the reverse order. In FIG. 3, the output beam 125 from light source 110 is first directed to the scan mirror 302, where it is reflected by reflective surface 321, and then the output beam 125 is directed to the polygon mirror 301, where it is reflected by reflective surface 320A.

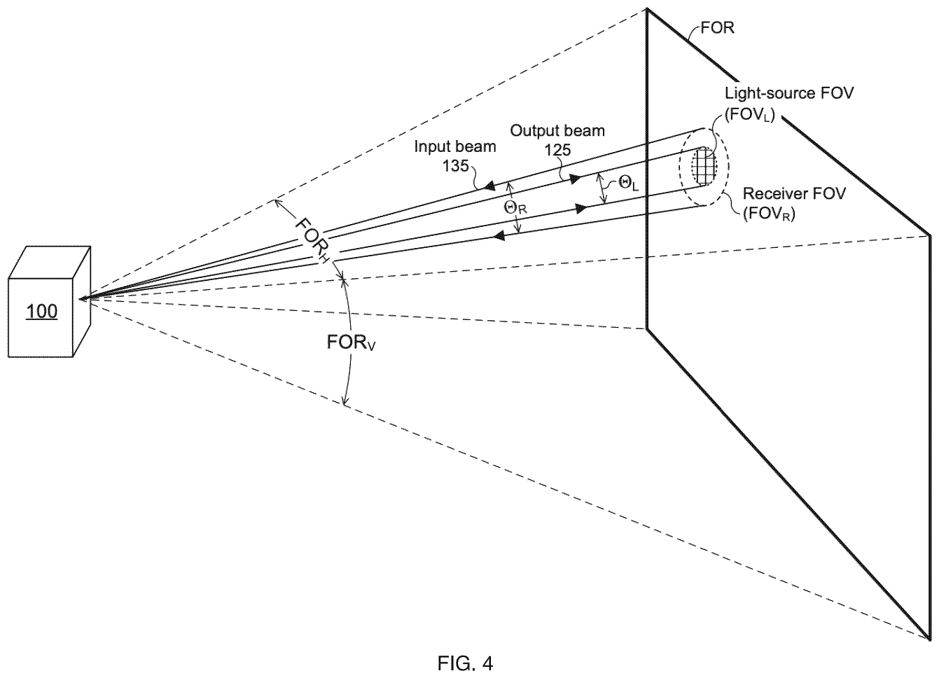

FIG. 4 illustrates an example light-source field of view (FOV_{L}) and receiver field of view (FOV_{R}) for a lidar system 100. A light source 110 of lidar system 100 may emit pulses of light as the FOV_{L} and FOV_{R} are scanned by scanner 120 across a field of regard (FOR). In particular embodiments, a light-source field of view may refer to an angular cone illuminated by the light source 110 at a particular instant of time. Similarly, a receiver field of view may refer to an angular cone over which the receiver 140 may receive or detect light at a particular instant of time, and any light outside the receiver field of view may not be received or detected. As an example, as the light-source field of view is scanned across a field of regard, a portion of a pulse of light emitted by the light source 110 may be sent downrange from lidar system 100, and the pulse of light may be sent in the direction that the FOV_{L} is pointing at the time the pulse is emitted. The pulse of light may scatter off a target 130, and the receiver 140 may receive and detect a portion of the scattered light that is directed along or contained within the FOV_{R}.

In particular embodiments, scanner 120 may be configured to scan both a light-source field of view and a receiver field of view across a field of regard of the lidar system 100. Multiple pulses of light may be emitted and detected as the scanner 120 scans the FOV_{L} and FOV_{R} across the field of regard of the lidar system 100 while tracing out a scan pattern 200. In particular embodiments, the light-source field of view and the receiver field of view may be scanned synchronously with respect to one another, so that as the FOV_{L} is scanned across a scan pattern 200, the FOV_{R} follows substantially the same path at the same scanning speed. Additionally, the FOV_{L} and FOV_{R} may maintain the same relative position to one another as they are scanned across the field of regard. As an example, the FOV_{L} may be substantially overlapped with or centered inside the FOV_{R} (as illustrated in FIG. 4), and this relative positioning between FOV_{L} and FOV_{R} may be maintained throughout a scan. As another example, the FOV_{R} may lag behind the FOV_{L} by a particular, fixed amount throughout a scan (e.g., the FOV_{R} may be offset from the FOV_{L} in a direction opposite the scan direction).

In particular embodiments, the FOV_{L} may have an angular size or extent Θ_{L} that is substantially the same as or that corresponds to the divergence of the output beam 125, and the FOV_{R} may have an angular size or extent Θ_{R} that corresponds to an angle over which the receiver 140 may receive and detect light. In particular embodiments, the receiver field of view may be any suitable size relative to the light-source field of view. As an example, the receiver field of view may be smaller than, substantially the same size as, or larger than the angular extent of the light-source field of view. In particular embodiments, the light-source field of view may have an angular extent of less than or equal to 50 milliradians, and the receiver field of view may have an angular extent of less than or equal to 50 milliradians. The FOV_{L} may have any suitable angular extent Θ_{L}, such as for example, approximately 0.1 mrad, 0.2 mrad, 0.5 mrad, 1 mrad, 1.5 mrad, 2 mrad, 3 mrad, 5 mrad, 10 mrad, 20 mrad, 40 mrad, or 50 mrad. Similarly, the FOV_{R} may have any suitable angular extent Θ_{R}, such as for example, approximately 0.1 mrad, 0.2 mrad, 0.5 mrad, 1 mrad, 1.5 mrad, 2 mrad, 3 mrad, 5 mrad, 10 mrad, 20 mrad, 40 mrad, or 50 mrad. In particular embodiments, the light-source field of view and the receiver field of view may have approximately equal angular extents. As an example, Θ_{L} and Θ_{R} may both be approximately equal to 1 mrad, 2 mrad, or 4 mrad. In particular embodiments, the receiver field of view may be larger than the light-source field of view, or the light-source field of view may be larger than the receiver field of view. As an example, Θ_{L} may be approximately equal to 3 mrad, and Θ_{R} may be approximately equal to 4 mrad. As another example, Θ_{R} may be approximately K times larger than Θ_{L}, where K is any suitable factor, such as for example, 1.1, 1.2, 1.5, 2, 3, 5, or 10.

In particular embodiments, a pixel 210 may represent or may correspond to a light-source field of view or a receiver field of view. As the output beam 125 propagates from the light source 110, the diameter of the output beam 125 (as well as the size of the corresponding pixel 210) may increase according to the beam divergence Θ_{L}. As an example, if the output beam 125 has a Θ_{L} of 2 mrad, then at a distance of 100 m from the lidar system 100, the output beam 125 may have a size or diameter of approximately 20 cm, and a corresponding pixel 210 may also have a corresponding size or diameter of approximately 20 cm. At a distance of 200 m from the lidar system 100, the output beam 125 and the corresponding pixel 210 may each have a diameter of approximately 40 cm.

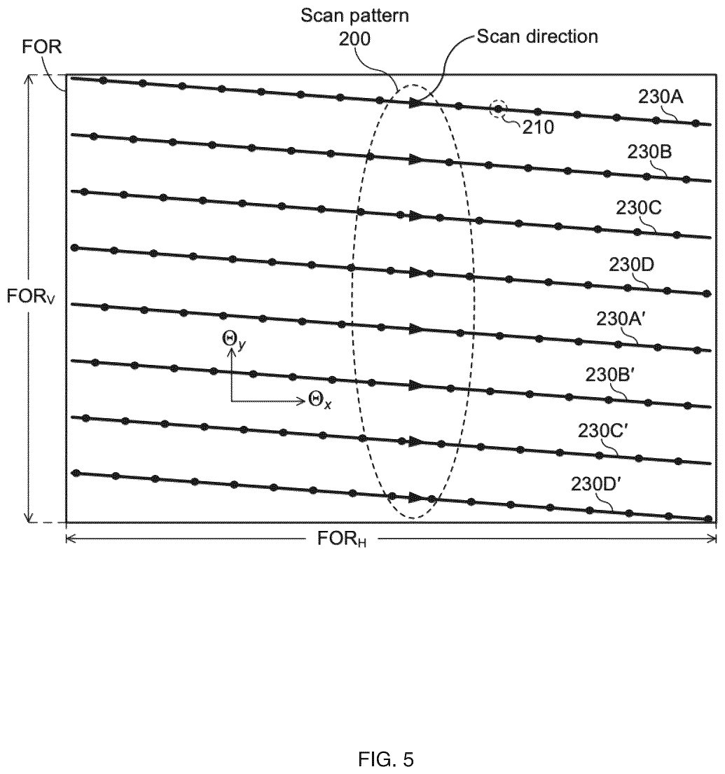

FIG. 5 illustrates an example unidirectional scan pattern 200 that includes multiple pixels 210 and multiple scan lines 230. In particular embodiments, scan pattern 200 may include any suitable number of scan lines 230 (e.g., approximately 1, 2, 5, 10, 20, 50, 100, 500, or 1,000 scan lines), and each scan line 230 of a scan pattern 200 may include any suitable number of pixels 210 (e.g., 1, 2, 5, 10, 20, 50, 100, 200, 500, 1,000, 2,000, or 5,000 pixels). The scan pattern 200 illustrated in FIG. 5 includes eight scan lines 230, and each scan line 230 includes approximately 16 pixels 210. In particular embodiments, a scan pattern 200 where the scan lines 230 are scanned in two directions (e.g., alternately scanning from right to left and then from left to right) may be referred to as a bidirectional scan pattern 200, and a scan pattern 200 where the scan lines 230 are scanned in the same direction may be referred to as a unidirectional scan pattern 200. The scan pattern 200 in FIG. 2 may be referred to as a bidirectional scan pattern, and the scan pattern 200 in FIG. 5 may be referred to as a unidirectional scan pattern 200 where each scan line 230 travels across the FOR in substantially the same direction (e.g., approximately from left to right as viewed from the lidar system 100). In particular embodiments, scan lines 230 of a unidirectional scan pattern 200 may be directed across a FOR in any suitable direction, such as for example, from left to right, from right to left, from top to bottom, from bottom to top, or at any suitable angle (e.g., at a 0°, 5°, 10°, 30°, or 45° angle) with respect to a horizontal or vertical axis. In particular embodiments, each scan line 230 in a unidirectional scan pattern 200 may be a separate line that is not directly connected to a previous or subsequent scan line 230.

In particular embodiments, a unidirectional scan pattern 200 may be produced by a scanner 120 that includes a polygon mirror (e.g., polygon mirror 301 of FIG. 3), where each scan line 230 is associated with a particular reflective surface 320 of the polygon mirror. As an example, reflective surface 320A of polygon mirror 301 in FIG. 3 may produce scan line 230A in FIG. 5. Similarly, as the polygon mirror 301 rotates, reflective surfaces 320B, 320C, and 320D may successively produce scan lines 230B, 230C, and 230D, respectively. Additionally, for a subsequent revolution of the polygon mirror 301, the scan lines 230A′, 230B′, 230C′, and 230D′ may be successively produced by reflections of the output beam 125 from reflective surfaces 320A, 320B, 320C, and 320D, respectively. In particular embodiments, N successive scan lines 230 of a unidirectional scan pattern 200 may correspond to one full revolution of an N-sided polygon mirror. As an example, the four scan lines 230A, 230B, 230C, and 230D in FIG. 5 may correspond to one full revolution of the four-sided polygon mirror 301 in FIG. 3. Additionally, a subsequent revolution of the polygon mirror 301 may produce the next four scan lines 230A′, 230B′, 230C′, and 230D′ in FIG. 5.

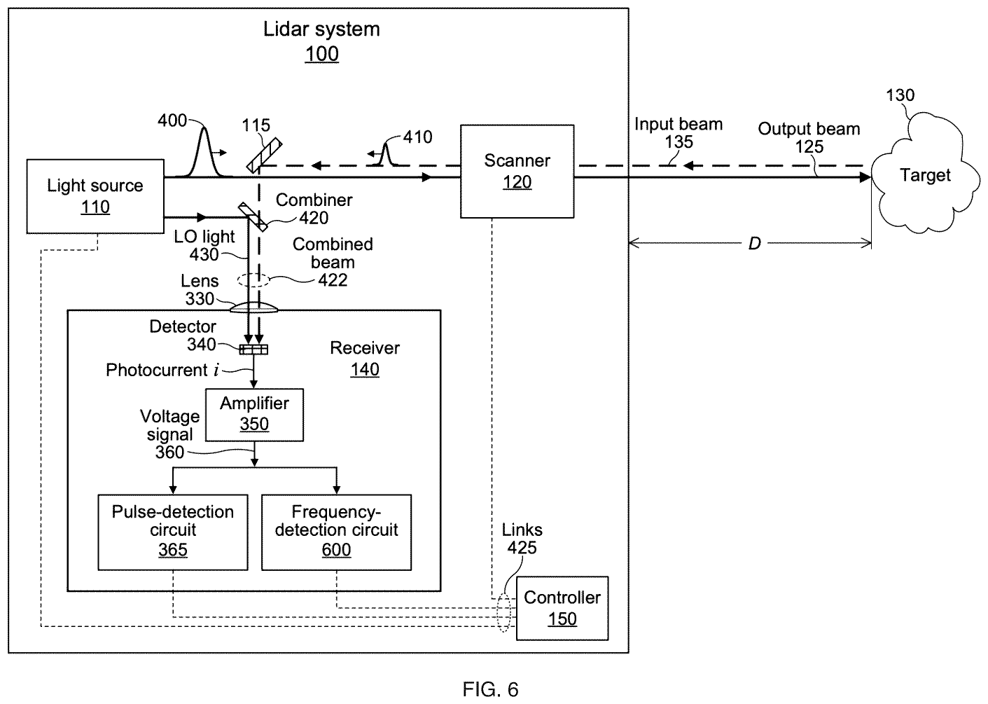

FIG. 6 illustrates an example lidar system 100 with a light source 110 that emits pulses of light 400 and local-oscillator (LO) light 430. The lidar system 100 in FIG. 6 includes a light source 110, a scanner 120, a receiver 140, and a controller 150. The receiver 140 includes a detector 340, an amplifier 350, a pulse-detection circuit 365, and a frequency-detection circuit 600. The lidar system 100 illustrated in FIG. 6 may be referred to as a coherent pulsed lidar system in which the light source 110 emits LO light 430 and pulses of light 400, where each emitted pulse of light 400 is coherent with a corresponding portion of the LO light 430. Additionally, the receiver 140 in a coherent pulsed lidar system may be configured to detect the LO light 430 and a received pulse of light 410, where the LO light 430 and the received pulse of light 410 (which includes scattered light from one of the emitted pulses of light 400) are coherently mixed together at the receiver 140. The LO light 430 may be referred to as a local-oscillator optical signal or a LO optical signal.

In particular embodiments, a coherent pulsed lidar system 100 may include a light source 110 configured to emit pulses of light 400 and LO light 430. The emitted pulses of light 400 may be part of an output beam 125 that is scanned by a scanner 120 across a field of regard of the lidar system 100, and the LO light 430 may be sent to a receiver 140 of the lidar system 100. The light source 110 may include a seed laser that produces seed light and the LO light 430. Additionally, the light source 110 may include an optical amplifier that amplifies the seed light to produce the emitted pulses of light 400. For example, the optical amplifier may be a pulsed optical amplifier that amplifies temporal portions of the seed light to produce the emitted pulses of light 400, where each amplified temporal portion of the seed light corresponds to one of the emitted pulses of light 400. The pulses of light 400 emitted by the light source 110 may have one or more of the following optical characteristics: a wavelength between 900 nm and 1700 nm; a pulse energy between 0.01 μJ and 100 μJ; a pulse repetition frequency between 80 kHz and 10 MHz; and a pulse duration between 0.1 ns and 20 ns. For example, the light source 110 may emit pulses of light 400 with a wavelength of approximately 1550 nm, a pulse energy of approximately 0.5 μJ, a pulse repetition frequency of approximately 750 kHz, and a pulse duration of approximately 5 ns. As another example, the light source 110 may emit pulses of light with a wavelength from approximately 1500 nm to approximately 1510 nm.

In particular embodiments, a coherent pulsed lidar system 100 may include a scanner 120 configured to scan an output beam 125 across a field of regard of the lidar system 100. The scanner 120 may receive the output beam 125 (which includes the emitted pulses of light 400) from the light source 110, and the scanner 120 may include one or more scanning mirrors configured to scan the output beam 125. In addition to scanning the output beam 125, the scanner may also scan a FOV of the detector 340 across the field of regard so that the output beam 125 and the detector FOV are scanned synchronously at the same scanning speed or with the same relative position to one another. Alternatively, the lidar system 100 may be configured so that only the output beam 125 is scanned, and the detector has a static FOV that is not scanned. In this case, the input beam 135 (which includes received pulses of light 410) may bypass the scanner 120 and be directed to the receiver 140 without passing through the scanner 120.

In particular embodiments, a coherent pulsed lidar system 100 may include an optical combiner 420 configured to optically combine LO light 430 with a received pulse of light 410. Optically combining LO light 430 with a received pulse of light 410 (which is part of the input beam 135) may include spatially overlapping the LO light 430 with the input beam 135 to produce a combined beam 422. The combined beam 422 may include light from the LO light 430 and the input beam 135 combined together so that the two beams propagate coaxially along the same path. For example, the combiner 420 in FIG. 6 may be a free-space optical beam-splitter that reflects at least part of the LO light 430 and transmits at least part of the input beam 135 so that the LO light 430 and the input beam 135 are spatially overlapped and propagate coaxially to the detector 340. As another example, the combiner 420 in FIG. 6 may be a mirror that reflects the LO light 430 and directs it to the detector 340, where it is combined with the input beam 135. As another example, a combiner 420 may include an optical-waveguide component or a fiber-optic component that spatially overlaps the LO light 430 and the input beam 135 so that the LO light 430 and the input beam 135 propagate together in a waveguide or in a core of an optical fiber.

In particular embodiments, a coherent pulsed lidar system 100 may include a receiver 140 that detects LO light 430 and received pulses of light 410. A received pulse of light 410 may include light from one of the emitted pulses of light 400 that is scattered by a target 130 located a distance from the lidar system 100. The receiver 140 may include one or more detectors 340, and the LO light 430 and a received pulse of light 410 may be coherently mixed together at one or more of the detectors 340. One or more of the detectors 340 may produce photocurrent signals that correspond to the coherent mixing of the LO light 430 and the received pulse of light 410. The lidar system 100 in FIG. 6 includes a receiver 140 with one detector 340 that receives the LO light 430 and the pulse of light 410, which are coherently mixed together at the detector 340. In response to the coherent mixing of the received LO light 430 and pulse of light 410, the detector 340 produces a photocurrent signal i that is amplified by an electronic amplifier 350.

In particular embodiments, a receiver 140 may include a pulse-detection circuit 365 that determines a time-of-arrival for a received pulse of light 410. The time-of-arrival for a received pulse of light 410 may correspond to a time associated with a rising edge, falling edge, peak, or temporal center of the received pulse of light 410. The time-of-arrival may be determined based at least in part on a photocurrent signal i produced by a detector 340 of the receiver 140. For example, a photocurrent signal i may include a pulse of current corresponding to the received pulse of light 410, and the electronic amplifier 350 may produce a voltage signal 360 with a voltage pulse that corresponds to the pulse of current. The pulse-detection circuit 365 may determine the time-of-arrival for the received pulse of light 410 based on a characteristic of the voltage pulse (e.g., based on a time associated with a rising edge, falling edge, peak, or temporal center of the voltage pulse). For example, the pulse-detection circuit 365 may receive an electronic trigger signal (e.g., from the light source 110 or the controller 150) when a pulse of light 400 is emitted, and the pulse-detection circuit 365 may determine the time-of-arrival for the received pulse of light 410 based on a time associated with an edge, peak, or temporal center of the voltage signal 360. The time-of-arrival may be determined based on a difference between a time when the pulse 400 is emitted and a time when the received pulse 410 is detected.

In particular embodiments, a coherent pulsed lidar system 100 may include a processor (e.g., controller 150) that determines the distance to a target 130 based at least in part on a time-of-arrival for a received pulse of light 410. The time-of-arrival for the received pulse of light 410 may correspond to a round-trip time (ΔT) for at least a portion of an emitted pulse of light 400 to travel to the target 130 and back to the lidar system 100, where the portion of the emitted pulse of light 400 that travels back to the target 130 corresponds to the received pulse of light 410. The distance D to the target 130 may be determined from the expression D=c·ΔT/2. For example, if the pulse-detection circuit 365 determines that the time ΔT between emission of optical pulse 400 and receipt of optical pulse 410 is 1 μs, then the controller 150 may determine that the distance to the target 130 is approximately 150 m. In particular embodiments, a round-trip time may be determined by a receiver 140, by a controller 150, or by a receiver 140 and controller 150 together. For example, a receiver 140 may determine a round-trip time by subtracting a time when a pulse 400 is emitted from a time when a received pulse 410 is detected. As another example, a receiver 140 may determine a time when a pulse 400 is emitted and a time when a received pulse 410 is detected. These values may be sent to a controller 150, and the controller 150 may determine a round-trip time by subtracting the time when the pulse 400 is emitted from the time when the received pulse 410 is detected.

In particular embodiments, a controller 150 of a lidar system 100 may be coupled to one or more components of the lidar system 100 via one or more data links 425. Each link 425 in FIG. 6 represents a data link that couples the controller 150 to another component of the lidar system 100 (e.g., light source 110, scanner 120, receiver 140, pulse-detection circuit 365, or frequency-detection circuit 600). Each data link 425 may include one or more electrical links, one or more wireless links, or one or more optical links, and the data links 425 may be used to send data, signals, or commands to or from the controller 150. For example, the controller 150 may send a command via a link 425 to the light source 110 instructing the light source 110 to emit a pulse of light 400. As another example, the pulse-detection circuit 365 may send a signal via a link 425 to the controller with information about a received pulse of light 410 (e.g., a time-of-arrival for the received pulse of light 410). Additionally, the controller 150 may be coupled via a link (not illustrated in FIG. 6) to a processor of an autonomous-vehicle driving system. The autonomous-vehicle processor may receive point-cloud data from the controller 150 and may make driving decisions based on the received point-cloud data.

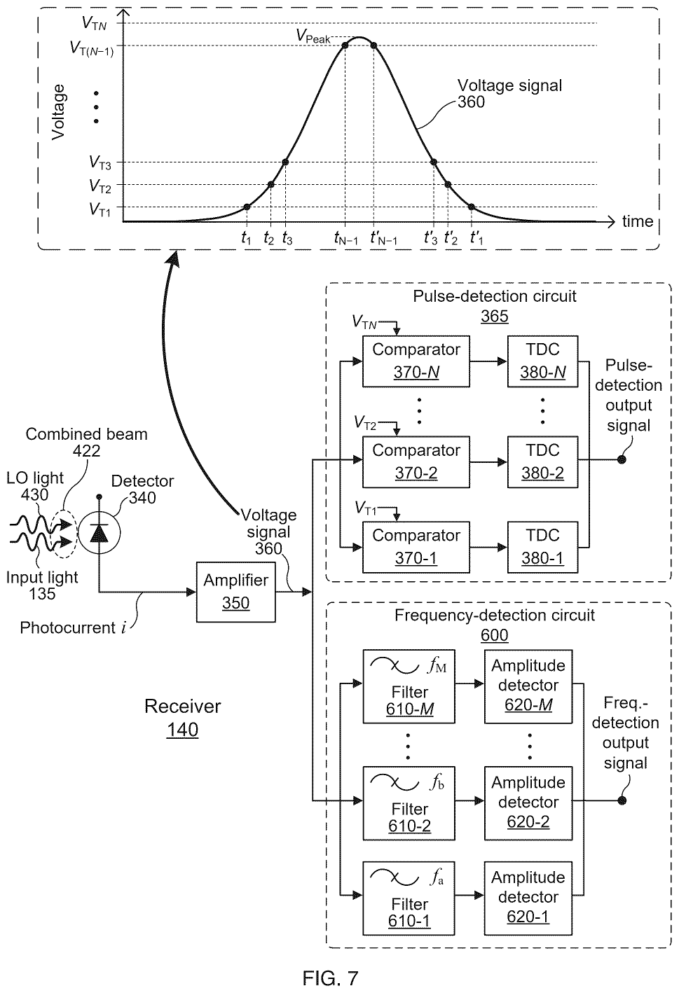

FIG. 7 illustrates an example receiver 140 and an example voltage signal 360 corresponding to a received pulse of light 410. A light source 110 of a lidar system 100 may emit a pulse of light 400, and a receiver 140 may be configured to detect a combined beam 422. The combined beam 422 in FIG. 7 includes LO light 430 and input light 135, where the input light 135 includes one or more received pulses of light 410. In particular embodiments, a receiver 140 of a lidar system 100 may include one or more detectors 340, one or more amplifiers 350, one or more pulse-detection circuits 365, or one or more frequency-detection circuits 600. A pulse-detection circuit 365 may include one or more comparators 370 or one or more time-to-digital converters (TDCs) 380. A frequency-detection circuit 600 may include one or more electronic filters 610 or one or more electronic amplitude detectors 620.

The receiver 140 illustrated in FIG. 7 includes a detector 340 configured to receive a combined beam 422 and produce a photocurrent i that corresponds to the coherent mixing of the LO light 430 and a received pulse of light 410 (which is part of the input light 135). The photocurrent i produced by the detector 340 may be referred to as a photocurrent signal or an electrical-current signal. The detector 340 may include an APD, PN photodiode, or PIN photodiode. For example, the detector 340 may include a silicon APD or PIN photodiode configured to detect light at an 800-1100 nm operating wavelength of a lidar system 100, or the detector 340 may include an InGaAs APD or PIN photodiode configured to detect light at a 1200-1600 nm operating wavelength. In FIG. 7, the detector 340 is coupled to an electronic amplifier 350 configured to receive the photocurrent i and produce a voltage signal 360 that corresponds to the received photocurrent. For example, the detector 340 may be an APD that produces a pulse of photocurrent in response to coherent mixing of LO light 430 and a received pulse of light 410, and the voltage signal 360 may be an analog voltage pulse that corresponds to the pulse of photocurrent. The amplifier 350 may include a transimpedance amplifier configured to receive the photocurrent i and amplify the photocurrent to produce a voltage signal that corresponds to the photocurrent signal. Additionally, the amplifier 350 may include a voltage amplifier that amplifies the voltage signal or an electronic filter (e.g., a low-pass or high-pass filter) that filters the photocurrent or the voltage signal.

In FIG. 7, the voltage signal 360 produced by the amplifier 350 is coupled to a pulse-detection circuit 365 and a frequency-detection circuit 600. The pulse-detection circuit includes N comparators (comparators 370-1, 370-2, . . . , 370-N), and each comparator is supplied with a particular threshold or reference voltage (V_{T1}, V_{T2}, . . . , V_{TN}). For example, receiver 140 may include N=10 comparators, and the threshold voltages may be set to 10 values between 0 volts and 1 volt (e.g., V_{T1}=0.1 V, V_{T2}=0.2 V, and V_{T10}=1.0 V). A comparator may produce an electrical-edge signal (e.g., a rising or falling electrical edge) when the voltage signal 360 rises above or falls below a particular threshold voltage. For example, comparator 370-2 may produce a rising edge when the voltage signal 360 rises above the threshold voltage V_{T2}. Additionally or alternatively, comparator 370-2 may produce a falling edge when the voltage signal 360 falls below the threshold voltage V_{T2}.

The pulse-detection circuit 365 in FIG. 7 includes N time-to-digital converters (TDCs 380-1, 380-2, . . . , 380-N), and each comparator is coupled to one of the TDCs. Each comparator-TDC pair in FIG. 7 (e.g., comparator 370-1 and TDC 380-1) may be referred to as a threshold detector. A comparator may provide an electrical-edge signal to a corresponding TDC, and the TDC may act as a timer that produces an electrical output signal (e.g., a digital signal, a digital word, or a digital value) that represents a time when the edge signal is received from the comparator. For example, if the voltage signal 360 rises above the threshold voltage V_{T1}, then the comparator 370-1 may produce a rising-edge signal that is supplied to the input of TDC 380-1, and the TDC 380-1 may produce a digital time value corresponding to a time when the edge signal was received by TDC 380-1. The digital time value may be referenced to the time when a pulse of light is emitted, and the digital time value may correspond to or may be used to determine a round-trip time for the pulse of light to travel to a target 130 and back to the lidar system 100. Additionally, if the voltage signal 360 subsequently falls below the threshold voltage V_{T1}, then the comparator 370-1 may produce a falling-edge signal that is supplied to the input of TDC 380-1, and the TDC 380-1 may produce a digital time value corresponding to a time when the edge signal was received by TDC 380-1.

In particular embodiments, a pulse-detection output signal may be an electrical signal that corresponds to a received pulse of light 410. For example, the pulse-detection output signal in FIG. 7 may be a digital signal that corresponds to the analog voltage signal 360, which in turn corresponds to the photocurrent signal i, which in turn corresponds to a received pulse of light 410. If an input light signal 135 includes a received pulse of light 410, the pulse-detection circuit 365 may receive a voltage signal 360 (corresponding to the photocurrent i) and produce a pulse-detection output signal that corresponds to the received pulse of light 410. The pulse-detection output signal may include one or more digital time values from each of the TDCs 380 that received one or more edge signals from a comparator 370, and the digital time values may represent the analog voltage signal 360. The pulse-detection output signal may be sent to a controller 150, and a time-of-arrival for the received pulse of light 410 may be determined based at least in part on the one or more time values produced by the TDCs. For example, the time-of-arrival may be determined from a time associated with the peak (e.g., Vₚₑₐₖ) of the voltage signal 360 or from a temporal center of the voltage signal 360. Alternatively, the time-of-arrival may be determined from a time associated with a rising edge of the voltage signal 360. The pulse-detection output signal in FIG. 7 may correspond to the electrical output signal 145 in FIG. 1.

In particular embodiments, a pulse-detection output signal may include one or more digital values that correspond to a time interval between (1) a time when a pulse of light 400 is emitted and (2) a time when a received pulse of light 410 is detected by a receiver 140. The pulse-detection output signal in FIG. 7 may include digital values from each of the TDCs that receive an edge signal from a comparator, and each digital value may represent a time interval between the emission of an optical pulse 400 by a light source 110 and the receipt of an edge signal from a comparator. For example, a light source 110 may emit a pulse of light 400 that is scattered by a target 130, and a receiver 140 may receive a portion of the scattered pulse of light as an input pulse of light 410. When the light source emits the pulse of light 400, a count value of the TDCs may be reset to zero counts. Alternatively, the TDCs in receiver 140 may accumulate counts continuously over two or more pulse periods (e.g., for 10, 100, 1,000, 10,000, or 100,000 pulse periods), and when a pulse of light 400 is emitted, the current TDC count may be stored in memory. After the pulse of light 400 is emitted, the TDCs may accumulate counts that correspond to elapsed time (e.g., the TDCs may count in terms of clock cycles or some fraction of clock cycles).

In FIG. 7, when TDC 380-1 receives an edge signal from comparator 370-1, the TDC 380-1 may produce a digital signal that represents the time interval between emission of the pulse of light 400 and receipt of the edge signal. For example, the digital signal may include a digital value that corresponds to the number of clock cycles that elapsed between emission of the pulse of light 400 and receipt of the edge signal. Alternatively, if the TDC 380-1 accumulates counts over multiple pulse periods, then the digital signal may include a digital value that corresponds to the TDC count at the time of receipt of the edge signal. The pulse-detection output signal may include digital values corresponding to one or more times when a pulse of light 400 was emitted and one or more times when a TDC received an edge signal. A pulse-detection output signal from a pulse-detection circuit 365 may correspond to a received pulse of light 410 and may include digital values from each of the TDCs that receive an edge signal from a comparator. The pulse-detection output signal may be sent to a controller 150, and the controller may determine the distance to the target 130 based at least in part on the pulse-detection output signal. Additionally or alternatively, the controller 150 may determine an optical characteristic of a received pulse of light 410 based at least in part on the pulse-detection output signal received from the TDCs of a pulse-detection circuit 365.

In particular embodiments, a receiver 140 of a lidar system 100 may include one or more analog-to-digital converters (ADCs). As an example, instead of including multiple comparators and TDCs, a receiver 140 may include an ADC that receives a voltage signal 360 from amplifier 350 and produces a digital representation of the voltage signal 360. Although this disclosure describes or illustrates example receivers 140 that include one or more comparators 370 and one or more TDCs 380, a receiver 140 may additionally or alternatively include one or more ADCs. As an example, in FIG. 7, instead of the N comparators 370 and N TDCs 380, the receiver 140 may include an ADC configured to receive the voltage signal 360 and produce a digital output signal that includes digitized values that correspond to the voltage signal 360.

The example voltage signal 360 illustrated in FIG. 7 corresponds to a received pulse of light 410. The voltage signal 360 may be an analog signal produced by an electronic amplifier 350 and may correspond to a pulse of light detected by the receiver 140 in FIG. 7. The voltage levels on the y-axis correspond to the threshold voltages V_{T1}, V_{T2}, . . . , V_{TN} of the respective comparators 370-1, 370-2, . . . , 370-N. The time values t₁, t₂, t₃, . . . , t_{N-1} correspond to times when the voltage signal 360 exceeds the corresponding threshold voltages, and the time values t′₁, t′₂, t′₃, . . . , t′_{N-1} correspond to times when the voltage signal 360 falls below the corresponding threshold voltages. For example, at time t₁ when the voltage signal 360 exceeds the threshold voltage V_{T1}, comparator 370-1 may produce an edge signal, and TDC 380-1 may output a digital value corresponding to the time t₁. Additionally, the TDC 380-1 may output a digital value corresponding to the time t′₁ when the voltage signal 360 falls below the threshold voltage V_{T1}. Alternatively, the receiver 140 may include an additional TDC (not illustrated in FIG. 7) configured to produce a digital value corresponding to time t′₁ when the voltage signal 360 falls below the threshold voltage V_{T1}. The pulse-detection output signal from pulse-detection circuit 365 may include one or more digital values that correspond to one or more of the time values t₁, t₂, t₃, . . . , t_{N-1} and t′₁, t′₂, t′₃, . . . , t′_{N-1}. Additionally, the pulse-detection output signal may also include one or more values corresponding to the threshold voltages associated with the time values. Since the voltage signal 360 in FIG. 7 does not exceed the threshold voltage V_{TN}, the corresponding comparator 370-N may not produce an edge signal. As a result, TDC 380-N may not produce a time value, or TDC 380-N may produce a signal indicating that no edge signal was received.

In particular embodiments, a pulse-detection output signal produced by a pulse-detection circuit 365 of a receiver 140 may correspond to or may be used to determine an optical characteristic of a received pulse of light 410 detected by the receiver 140. An optical characteristic of a received pulse of light 410 may correspond to a peak optical intensity, a peak optical power, an average optical power, an optical energy, a shape or amplitude, a temporal duration, or a temporal center of the received pulse of light 410. For example, a pulse of light 410 detected by receiver 140 may have one or more of the following optical characteristics: a peak optical power between 1 nanowatt and 10 watts; a pulse energy between 1 attojoule and 10 nanojoules; and a pulse duration between 0.1 ns and 50 ns. In particular embodiments, an optical characteristic of a received pulse of light 410 may be determined from a pulse-detection output signal provided by one or more TDCs 380 of a pulse-detection circuit 365 (e.g., as illustrated in FIG. 7), or an optical characteristic may be determined from a pulse-detection output signal provided by one or more ADCs of a pulse-detection circuit 365.

In particular embodiments, a peak optical power or peak optical intensity of a received pulse of light 410 may be determined from one or more values of a pulse-detection output signal provided by a receiver 140. As an example, a controller 150 may determine the peak optical power of a received pulse of light 410 based on a peak voltage (Vₚₑₐₖ) of the voltage signal 360. The controller 150 may use a formula or lookup table that correlates a peak voltage of the voltage signal 360 with a value for the peak optical power. In the example of FIG. 7, the peak optical power of a pulse of light 410 may be determined from the threshold voltage V_{T(N-1)}, which is approximately equal to the peak voltage Vₚₑₐₖ of the voltage signal 360 (e.g., the threshold voltage V_{T(N-1)} may be associated with a pulse of light 410 having a peak optical power of 10 mW). As another example, a controller 150 may apply a curve-fit or interpolation operation to the values of a pulse-detection output signal to determine the peak voltage of the voltage signal 360, and this peak voltage may be used to determine the corresponding peak optical power of a received pulse of light 410.

In particular embodiments, an energy of a received pulse of light 410 may be determined from one or more values of a pulse-detection output signal. For example, a controller 150 may perform a summation of digital values that correspond to a voltage signal 360 to determine an area under the voltage-signal curve, and the area under the voltage-signal curve may be correlated with a pulse energy of a received pulse of light 410. As an example, the approximate area under the voltage-signal curve in FIG. 7 may be determined by subdividing the curve into M subsections (where M is approximately the number of time values included in the pulse-detection output signal) and adding up the areas of each of the subsections (e.g., using a numerical integration technique such as a Riemann sum, trapezoidal rule, or Simpson's rule). For example, the approximate area A under the voltage-signal curve 360 in FIG. 7 may be determined from a Riemann sum using the expression A=Σₖ₌₁^{M}V_{Tk}×Δtₖ, where V_{Tk} is a threshold voltage associated with the time value tₖ, and Δtₖ is a width of the subsection associated with time value tₖ. In the example of FIG. 7, the voltage signal 360 may correspond to a received pulse of light 410 with a pulse energy of 1 picojoule.

In particular embodiments, a duration of a received pulse of light 410 may be determined from a duration or width of a corresponding voltage signal 360. For example, the difference between two time values of a pulse-detection output signal may be used to determine a duration of a received pulse of light 410. In the example of FIG. 7, the duration of the pulse of light 410 corresponding to voltage signal 360 may be determined from the difference (t′₃−t₃), which may correspond to a received pulse of light 410 with a pulse duration of 4 nanoseconds. As another example, a controller 150 may apply a curve-fit or interpolation operation to the values of the pulse-detection output signal, and the duration of the pulse of light 410 may be determined based on the curve-fit or interpolation. One or more of the approaches for determining an optical characteristic of a received pulse of light 410 as described herein may be implemented using a receiver 140 that includes multiple comparators 370 and TDCs 380 (as illustrated in FIG. 7) or using a receiver 140 that includes one or more ADCs.

In FIG. 7, the voltage signal 360 produced by amplifier 350 is coupled to a frequency-detection circuit 600 as well as a pulse-detection circuit 365. The pulse-detection circuit 365 may provide a pulse-detection output signal that is used to determine time-domain information for a received pulse of light 410 (e.g., a time-of-arrival, duration, or energy of the received pulse of light 410), and the frequency-detection circuit 600 may provide frequency-domain information for the received pulse of light 410. For example, the frequency-detection output signal of the frequency-detection circuit 600 may include amplitude information for particular frequency components of the received pulse of light 410. The frequency-detection output signal may include the amplitude of one or more frequency components of a received pulse of light 410, and this amplitude information may be sent to a controller 150 for further processing. For example, the controller 150 may determine, based at least in part on the amplitude information, whether a received pulse of light is a valid received pulse of light 410 or an interfering pulse of light.

In particular embodiments, a frequency-detection circuit 600 may include multiple parallel frequency-measurement channels, and each frequency-measurement channel may include a filter 610 and a corresponding amplitude detector 620. In FIG. 7, the frequency-detection circuit 600 includes M electronic filters (filters 610-1, 610-2, . . . , 610-M), where each filter is associated with a particular frequency component (frequencies fₐ, f_{b}, . . . , f_{M}). Each filter 610 in FIG. 7 may include an electronic band-pass filter having a particular pass-band center frequency and width. For example, filter 610-2 may be a band-pass filter with a center frequency f_{b} of 1 GHz and a pass-band width of 20 MHz. Each filter 610 may include a passive filter implemented with one or more passive electronic components (e.g., one or more resistors, inductors, or capacitors). Alternatively, each filter 610 may include an active filter that includes one or more active electronic components (e.g., one or more transistors or op-amps) along with one or more passive components.

In addition to the M electronic filters 610, the frequency-detection circuit 600 in FIG. 7 also includes M electronic amplitude detectors (amplitude detectors 620-1, 620-2, . . . , 620-M). An amplitude detector 620 may be configured to provide an output signal that corresponds to an amplitude (e.g., a peak value, a size, or an energy) of an electrical signal received from a filter 610. For example, filter 610-M may receive voltage signal 360 and provide to amplitude detector 620-M the portion of the voltage signal 360 having a frequency component at or near the frequency f_{M}. The amplitude detector 620-M may produce a digital or analog output signal that corresponds to the amplitude, peak value, size, or energy of the signal associated with the frequency component f_{M}. Each amplitude detector 620 may include a sample-and-hold circuit, a peak-detector circuit, an integrator circuit, or an ADC. For example, amplitude detector 620-M may include a sample-and-hold circuit and an ADC. The sample-and-hold circuit may produce an analog voltage corresponding to the amplitude of a signal received from filter 610-M, and the ADC may produce a digital signal that represents the analog voltage.

A frequency-detection circuit 600 may include 1, 2, 4, 8, 10, 20, or any other suitable number of filters 610 and amplitude detectors 620, and each filter may have a center frequency between approximately 200 MHz and approximately 20 GHz. Additionally, each filter 610 may include a band-pass filter having a pass-band with a frequency width of approximately 1 MHz, 10 MHz, 20 MHz, 50 MHz, 100 MHz, 200 MHz, or any other suitable frequency width. For example, a frequency-detection circuit 600 may include four band-pass filters 610 with center frequencies of approximately 1.0 GHz, 1.1 GHz, 1.2 GHz, and 1.3 GHz, and each filter may have a pass-band with a frequency width of approximately 20 MHz. A 1.0-GHz filter with a 20-MHz pass-band may pass or transmit frequency components from approximately 0.99 GHz to approximately 1.01 GHz and may attenuate frequency components outside of that frequency range.

In particular embodiments, a light source 110 of a lidar system 100 may impart a particular spectral signature to an emitted pulse of light 400. A spectral signature (which may be referred to as a frequency signature, frequency tag, or frequency change) may correspond to the presence or absence of particular frequency components that are imparted to an emitted pulse of light 400. Additionally or alternatively, a spectral signature may include an amplitude modulation, frequency modulation, or frequency change applied to an emitted pulse of light 400. For example, a spectral signature may include an amplitude or frequency modulation at a particular frequency (e.g., 1 GHz) that is applied to an emitted pulse of light 400. As another example, a spectral signature may include an amplitude or frequency modulation at two or more particular frequencies (e.g., 1.6 GHz and 2.0 GHz) that is applied to an emitted pulse of light 400. A received pulse of light 410 may include the same spectral signature that was applied to an associated emitted pulse of light 400, and the photocurrent signal i (as well as the corresponding voltage signal 360) may include one or more frequency components that correspond to the spectral signature. A frequency-detection circuit 600 may determine, based on the voltage signal 360 (which corresponds to the photocurrent signal i), one or more amplitudes of the one or more frequency components. In the example of FIG. 7, the frequency-detection circuit 600 may include M band-pass filters 610 and M amplitude detectors 620. Each band-pass filter 610 may have a center frequency corresponding to one of the frequency components (from fₐ to f_{M}), and each amplitude detector 620 may produce a signal corresponding to the amplitude of one of the respective frequency components. The frequency-detection output signal produced by the frequency-detection circuit 600 may include M digital values corresponding to the amplitudes of the M frequency components.

In particular embodiments, a controller 150 may determine, based on the amplitudes of one or more frequency components associated with a received pulse of light 410, whether the received pulse of light 410 is associated with a particular emitted pulse of light 400. If one or more frequency components of a received pulse of light 410 match a spectral signature of a particular emitted pulse of light 400, then the controller 150 may determine that the received pulse of light 410 is associated with the particular emitted pulse of light 400 (e.g., the received pulse of light 410 includes scattered light from the emitted pulse of light 400). Otherwise, if the frequency components do not match, then the controller 150 may determine that the received pulse of light 410 is not associated with the particular emitted pulse of light 400. For example, the received pulse of light 410 may be associated with a different pulse of light 400 emitted by the light source 110 of the lidar system 100, or the received pulse of light 410 may be associated with an interfering optical signal emitted by a different light source external to the lidar system 100. As another example, a particular pulse of light 400 emitted by the light source 110 may include a spectral signature with an amplitude modulation at a particular frequency (e.g., 2 GHz), and a frequency-detection circuit 600 may include a filter 610 and amplitude detector 620 that determine the amplitude of a 2-GHz frequency component for a received pulse of light 410. If the amplitude of the 2-GHz frequency component is greater than a particular threshold value (or within a range of two particular threshold values), then the controller 150 may determine that the received pulse of light 410 is associated with and includes light from the particular emitted pulse of light 400. Otherwise, if the amplitude of the 2-GHz frequency component is less than the particular threshold value, then the controller 150 may determine that the received pulse of light 410 is not associated with and does not include light from the particular emitted pulse of light 400. Additionally or alternatively, if the amplitude of a different frequency component (e.g., a 1.8-GHz frequency component) that is not part of a particular spectral signature is greater than a particular threshold value, then the controller may determine that the received pulse of light 400 is not associated with the emitted pulse of light 400 having that particular spectral signature.

In particular embodiments, the amplitudes of the one or more frequency components associated with a received pulse of light 410 may be scaled by a scaling factor. This scaling of the frequency-component amplitudes may be used to compensate for a decrease in the energy, power, or intensity of a received pulse of light 410 as a function of distance of the target 130 from the lidar system 100. A controller 150 may receive, from a frequency-detection circuit 600, digital values corresponding to the amplitudes of one or more frequency components of a received pulse of light 410. Prior to comparing the frequency-component values to threshold values to determine whether the received pulse of light 410 is valid, the frequency-component values may be divided by a scaling factor that corresponds to an optical characteristic of the received pulse of light 410 (e.g., the energy, peak power, or peak intensity of the received pulse of light 410). Alternatively, the frequency-component amplitudes may be multiplied by a scaling factor that corresponds to D or D², where D is a distance to the target 130 from which the corresponding emitted pulse of light was scattered.

In particular embodiments, a light source 110 may emit pulses of light 400 where each emitted pulse of light 400 has a particular spectral signature of one or more different spectral signatures. The spectral signatures may be used to determine whether a received pulse of light is a valid received pulse of light 410 that is associated with an emitted pulse of light 400. A valid received pulse of light 410 may refer to a received pulse of light 410 that includes scattered light from a pulse of light 400 that was emitted by the light source 110. For example, a light source 110 may emit pulses of light 400 that each include the same spectral signature. If a received pulse of light matches that same spectral signature, then the received pulse of light may be determined to be a valid received pulse of light 410 that is associated with an emitted pulse of light 400. As another example, a light source 110 may emit pulses of light 400 that each include one spectral signature of two or more different spectral signatures. If a received pulse of light matches one of the spectral signatures, then the received pulse of light may be determined to be a valid received pulse of light 410 that is associated with an emitted pulse of light 400.

In particular embodiments, a received pulse of light may be determined to match a particular spectral signature if the received pulse of light includes each of the one or more frequency components associated with the particular spectral signature. Additionally, a received pulse of light may be determined to match the particular spectral signature if the received pulse of light does not include any frequency components that are not associated with the particular spectral signature. Similarly, a received pulse of light may be determined to not match a spectral signature if (i) the received pulse of light does not include all of the one or more frequency components associated with the spectral signature or (ii) the received pulse of light includes one or more frequency components not associated with the spectral signature. Determining whether a received pulse of light 410 includes a particular frequency component may include determining the amplitude of the particular frequency component (e.g., based on a signal from an amplitude detector 620). If the amplitude of the particular frequency component is greater than a particular threshold value (or between a minimum threshold value and a maximum threshold value), then a controller 150 may determine that a received pulse of light 410 includes the particular frequency component. Additionally or alternatively, if the amplitude of the particular frequency component is less than the particular threshold value, then the controller 150 may determine that the received pulse of light 410 does not include the particular frequency component.

In particular embodiments, a light source 110 may emit pulses of light 400 where each emitted pulse of light 400 has a particular spectral signature of two or more different spectral signatures, and the spectral signatures may be used to associate a received pulse of light 410 with a particular emitted pulse of light 400. For example, a light source 110 may emit pulses of light 400 with spectral signatures that alternate (e.g., sequentially or in a pseudo-random manner) between two, three, four, or any other suitable number of different spectral signatures. One spectral signature may include an amplitude modulation at 1.5 GHz, and another spectral signature may include an amplitude modulation at 1.7 GHz. A frequency-detection circuit 600 may include two filters and amplitude detectors that determine the amplitudes of the frequency components at 1.5 GHz and 1.7 GHz. Based on the amplitudes of the 1.5-GHz and 1.7-GHz frequency components of a received pulse of light 410, the controller 150 may determine whether the received pulse of light 410 is associated with an emitted pulse of light 400 having a 1.5-GHz spectral signature or a 1.7-GHz spectral signature. If a light source 110 emits a first pulse with a 1.5-GHz modulation and a second pulse with a 1.7-GHz modulation, then a controller 150 may determine that a received pulse of light 410 with a 1.5-GHz frequency component is associated with the first emitted pulse. Emitting pulses of light 400 that have different spectral signatures may allow a frequency-detection circuit 600 and controller 150 to prevent problems with ambiguity as to which emitted pulse a received pulse is associated with. A received pulse of light 410 may be unambiguously associated with an emitted pulse of light 400 based on the frequency components of the received pulse of light 410 matching the spectral signature of the emitted pulse of light 400.

In particular embodiments, a light source 110 may emit pulses of light 400 where each emitted pulse of light 400 has a particular spectral signature of one or more different spectral signatures, and the spectral signatures may be used to determine whether a received pulse of light is a valid received pulse of light 410 or an interfering optical signal. An interfering optical signal may refer to an optical signal that is sent by a light source external to the lidar system 100. For example, another lidar system may emit a pulse of light that is detected by the receiver 140, and the received pulse of light may be determined to be an interfering optical signal since it does not match the spectral signatures of the emitted pulses of light 400 from the light source 110. A controller 150 may distinguish valid pulses from interfering pulses by comparing the frequency components for a received pulse of light with the expected frequency components associated with the spectral signatures imparted to emitted pulses of light 400. If the frequency components of a received pulse of light do not match any of the one or more different spectral signatures imparted to the emitted pulses of light 400, then the controller 150 may determine that the received pulse of light is invalid and is not associated with any of the emitted pulses of light 400. For example, the received pulse of light may be an interfering pulse of light sent from a light source external to the lidar system 100, and the interfering pulse of light may be discarded or ignored since it is not associated with any of the emitted pulses of light 400.

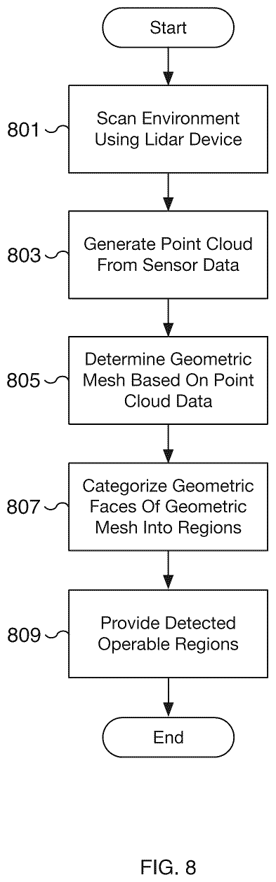

FIG. 8 is a flow chart illustrating an embodiment of a process for estimating the drivable surface of an environment using a lidar device. For example, using the process of FIG. 8, a geometric mesh estimating the surface of the surrounding environment can be generated from lidar point cloud data. The geometric mesh is then analyzed to determine which portions correspond to drivable (or operable) regions. In some embodiments, the vertices of the determined geometric mesh correspond to point cloud pixels and are assigned operable parameters such as whether the location associated with the geometric mesh vertex corresponds to a drivable region and/or the drivability of the region. In some embodiments, the process of FIG. 8 is performed using a lidar system such as lidar system 100 as shown in FIGS. 1-4 and 6. In some embodiments, the process is performed at least in part by a controller of a lidar system such as controller 150 of lidar system 100 as shown in FIGS. 1 and 6 and/or one or more processors associated with the lidar system.

At 801, the environment is scanned using a lidar device. For example, the surrounding environment of a vehicle equipped with a lidar device is scanned using the installed lidar device. In some embodiments, the scanned environment corresponds to a lidar system's configured field of regard. In various embodiments, the environment is scanned to determine distances of targets in the field of regard and corresponding intensity measurements for particular azimuth and altitude values. The azimuth and altitude values can correspond to angular values that represent the measured angular location with respect to the lidar system. In some embodiments, the altitude values are elevation values. In some embodiments, the horizontal and vertical locations scanned with respect to the lidar system are tracked using a different reference system other than azimuth and altitude values.

At 803, a point cloud is generated from the lidar sensor data. For example, using captured lidar measurements, a point cloud representing the environment surrounding the vehicle on which the lidar device is installed is generated. The generated point cloud can correspond to a three-dimensional representation of the scanned environment and its surface as it relates to the vehicle's position. In various embodiments, the pixels or points of the point cloud can include measurement data such as a distance value, an intensity value, a confidence value, and/or other measurement values for particular azimuth and altitude (or horizontal and vertical) values with respect to the lidar sensor.

At 805, a geometric mesh is determined based on the point cloud data. For example, the point cloud data is used to create a geometric mesh that estimates the surface of the surrounding environment. In some embodiments, the geometric mesh is created in at least two distinct steps. The first step creates a two-dimensional geometric mesh using the point cloud data. The two-dimensional geometric mesh can be created by triangulating a set of points, where the points are based on the azimuth and altitude values of the pixels in the generated point cloud. As another example, a two-dimensional geometric mesh can be created by triangulating a set of points based on the horizontal and vertical values of the generated point cloud pixels. In various embodiments, the two-dimensional mesh is created independent of lidar measured distance and/or intensity values. However, once the two-dimensional mesh is generated, each vertex of the mesh can be assigned a third dimensional value such as the distance of the corresponding point cloud pixel. The inclusion of distance data converts the two-dimensional mesh into a three-dimensional geometric mesh where the faces of the three-dimensional geometric mesh are no longer necessarily co-planar.

At 807, the geometric faces of the geometric mesh are categorized into regions. For example, the faces of the three-dimensional geometric mesh are grouped into regions based on the locations' drivable and/or operable characteristics. In some embodiments, the selection criteria are based on how flat or steep the face is. For example, the normal of the faces can be compared to the face closest to the lidar device and/or to neighboring or known drivable faces. In some embodiments, seed faces are first selected and flooded to determine contiguous regions of faces with similar attributes including slope, normal vectors, and/or intensity values. In various embodiments, the geometric faces are categorized into regions where drivable regions can correspond to drivable surfaces such as roads and non-drivable regions can correspond to obstacles such as buildings, walls, fences, road debris, etc.

At 809, the detected operable regions of the geometric mesh are provided. For example, regions corresponding to an operable surface are provided. In some embodiments, the operable regions are provided along with drivable coefficients that correspond to an evaluation on the drivability of a path through the faces of the region. For example, slippery or rough terrain may have a low drivability coefficient whereas smooth roads or highway surfaces may have a high drivability coefficient. In some embodiments, the detected operable regions are provided as a set of vertices that correspond to point cloud data.

In various embodiments, detected operable regions data provided at 809 can be used for upstream processing including processing performed by an advanced driver assistance system (ADAS) to assist a driver of the vehicle in operating the vehicle. For example, the detected operable regions can be used to provide information (e.g., drivable surfaces in the surrounding environment) or feedback to a driver (e.g., to alert the driver to potential problems or hazards). In some embodiments, the detected operable regions can be used as part of a process that automatically takes control of part of a vehicle (e.g., a braking system or a steering system) to avoid collisions or accidents. In various embodiments, the detected operable regions can be used for functionality such as adaptive cruise control, automated braking, automated parking, collision avoidance, alerting the driver to hazards or other vehicles, maintaining the vehicle in the correct lane, providing a warning if an object or another vehicle is in a blind spot, adjusting the torque applied to the wheels, adjusting the difference in torque applied at each wheel, and/or engaging or disengaging one or more axles or wheels of the vehicle, among other driving assistance functionality.

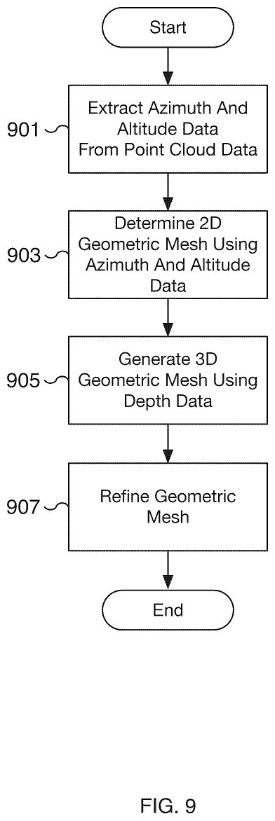

FIG. 9 is a flow chart illustrating an embodiment of a process for generating a geometric mesh for estimating the surface of a surrounding environment. For example, using the process of FIG. 9, a three-dimensional geometric mesh estimating the surface of the surrounding environment can be generated from lidar point cloud data including lidar detection data. To generate the three-dimensional geometric mesh, a two-dimensional mesh is first determined and then expanded into three dimensions using additional point cloud data measurements. In various embodiments, the two-dimensional mesh is generated by triangulating the two-dimensional azimuth and altitude (or corresponding horizontal and vertical) locations of point cloud pixels. In some embodiments, the process of FIG. 9 is performed at 805 of FIG. 8. In some embodiments, the process of FIG. 9 is performed using a lidar system such as lidar system 100 as shown in FIGS. 1-4 and 6. In some embodiments, the process is performed at least in part by a controller of a lidar system such as controller 150 of lidar system 100 as shown in FIGS. 1 and 6 and/or one or more processors associated with the lidar system.

At 901, azimuth and altitude data are extracted from generated point cloud data. For example, for each pixel of the point cloud, its azimuth and altitude data are extracted as a potential vertex. The azimuth and altitude values can correspond to angular values for the angular location of a pixel with respect to the lidar system. In some embodiments, the altitude data is elevation data. Using the extracted azimuth and altitude data, a set of potential vertex locations is created. In some embodiments, horizontal and vertical location values of each point cloud pixel are used instead of azimuth and altitude values.

At 903, a two-dimensional geometric mesh is determined using azimuth and altitude data. For example, geometric faces of a two-dimensional flat geometric mesh are determined from the azimuth and altitude data extracted at 901. In some embodiments, the set of points based on extracted azimuth and altitude data are converted into two-dimensional geometric faces of a two-dimensional flat geometric mesh. The determined faces can be triangles although alternative geometric faces including rectangles and other polygons can be utilized as well. In some embodiments, the set of points are triangulated (or formed into triangles) to generate a two-dimensional flat geometric mesh of triangles. For example, the Delaunay triangulation of the set of points based on the extracted azimuth and altitude data can be used to determine the geometric faces of a two-dimensional geometric mesh. In some embodiments, the faces are determined by evaluating the areas of the faces, the lengths of the edges, the interior angles of the triangles, and/or other properties of the faces including in relation to neighboring faces as part of triangulating the points into a flat geometric mesh. For example, triangles that are very slender or long may be avoided and/or triangles with uniform shape/area and/or interior angles may be preferred. In various embodiments, alternative techniques to partition the points into geometric faces are appropriate as well.

At 905, a three-dimensional geometric mesh is generated using depth data. For example, the two-dimensional flat geometric mesh determined at 903 is expanded to three dimensions by adding depth data for each vertex. In various embodiments, the depth data added for each vertex of the mesh is based on the lidar distance measurement for the corresponding point cloud pixel. The addition of depth data at 905 generates a three-dimensional geometric mesh where the geometric faces of the mesh are no longer necessarily co-planar. In some embodiments, the vertices can be assigned additional parameters and/or coefficients such as an intensity value, a material category, and/or a confidence score, etc. to describe the properties of the location corresponding to the vertex.

At 907, the geometric mesh is refined. For example, the geometric mesh is refined to improve the accuracy of the mesh as an estimate for the surrounding surface. In some embodiments, the refinement step analyzes the geometric faces of the mesh and/or the vertices of the mesh, for example, to reduce noise and/or irregularities. The irregular faces can be modified, the impacted region and/or vertices re-triangulated, and/or the face and/or corresponding vertex removed from the geometric mesh, among other refinement techniques. In some embodiments, the analysis process evaluates the properties of the determined geometric faces. The properties evaluated can include the length of an edge of a face, an area of a face, one or more intensity values associated with a face, a value of an angle of a face, or a confidence score associated with a face, among other properties. For example, triangles with vertices with very different intensities can be refined or filtered. As another example, an area with a low confidence score can be marked for a subsequent scan at a higher resolution or density. In some embodiments, one or more heuristics are applied to improve the geometric mesh.

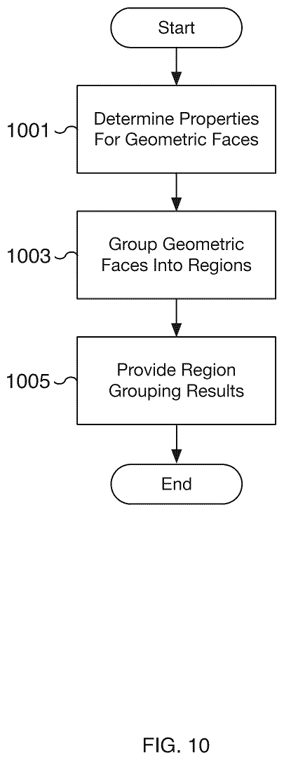

FIG. 10 is a flow chart illustrating an embodiment of a process for grouping a geometric mesh into regions. For example, using the process of FIG. 10, a three-dimensional geometric mesh estimating the surface of the surrounding environment is analyzed to select the faces of the mesh into one or more grouped regions. In various embodiments, the geometric faces grouped into the same region by selection criteria can be designed as drivable or non-drivable regions. In some embodiments, the region includes additional properties such as drivable coefficients that describe the region and its location. For example, a region of faces can correspond to a detected obstacle of a particular material.

In some embodiments, the process of FIG. 10 is applied to the entire geometric mesh or alternatively to subdivided portions of the geometric mesh. For example, the geometric mesh can be subdivided into smaller sections and the faces analyzed by subsection. In some embodiments, the process of FIG. 10 is performed at 807 and/or 809 of FIG. 8. In some embodiments, the process of FIG. 10 is performed using a lidar system such as lidar system 100 as shown in FIGS. 1-4 and 6. In some embodiments, the process is performed at least in part by a controller of a lidar system such as controller 150 of lidar system 100 as shown in FIGS. 1 and 6 and/or one or more processors associated with the lidar system.

At 1001, properties for the geometric faces are determined. For example, properties such as the normal vectors and heights of the geometric faces are determined. In some embodiments, one or more intensity values are determined for each face. Based on the determined properties, the faces can be subsequently selected into contiguous regions by selection criteria. For example, the normal of a face can be used to determine whether the corresponding surface is relatively flat or corresponds to a mild incline, a steep slope, a sharp drop off, a vertical wall, etc. In some embodiments, the height of one or more faces are calculated. For example, the height (or altitude/elevation) of each vertex of a face is determined and averaged to determine a face height for a geometric face.

At 1003, the geometric faces are grouped into regions. For example, the faces are grouped into contiguous regions by selection criteria. In some embodiments, the grouping is performed by selecting seed faces and flooding from the seed faces to contiguous neighboring faces. Faces that meet the selection criteria are grouped into the same region. For example, faces with normal vectors similar to the seed and/or another reference face are grouped together. In some embodiments, the intensity values of the faces are also used for the grouping criteria. In various embodiments, multiple seeds are used to evaluate the entire scene and to capture discrete and/or isolated regions. In some embodiments, when a face is encountered that does not meet the selection criteria, the excluded face is used as a seed face and flooded to determine a different region group.

At 1005, the region grouping results are provided. For example, the result from the grouping performed at 1003 is provided. In some embodiments, the provided region results include providing the regions that are drivable (or operable) by a vehicle and correspond to designated roads and drivable surfaces. In some embodiments, the provided region results include detected objects such as hazards, signs, other vehicles, road debris, etc. In various embodiments, the provided region results can be provided based on face, vertex, and/or a grouping of faces and/or vertices. In some embodiments, the provided region results include additional properties of the region such as a drivability coefficient among other determined properties of the region and its faces.

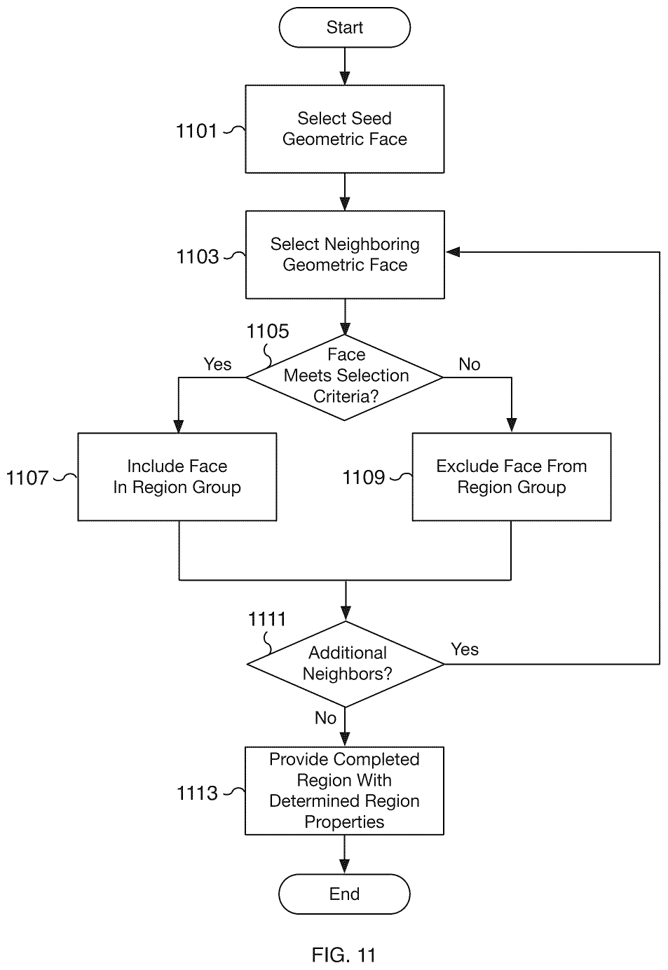

FIG. 11 is a flow chart illustrating an embodiment of a process for selecting a group of faces into a region group using a seed face. For example, using the process of FIG. 11, a three-dimensional geometric mesh is iteratively processed to select the faces of the mesh into a region group having particular selection criteria. In various embodiments, the geometric faces grouped into the same region by selection criteria can be designed as drivable or non-drivable regions. In some embodiments, the process of FIG. 11 is applied to the entire geometric mesh or alternatively to subdivided portions of the geometric mesh. For example, the geometric mesh can be subdivided into smaller sections and the faces analyzed by subsection. In some embodiments, the process of FIG. 11 is performed at 807 and/or 809 of FIG. 8 and/or 1003 and/or 1005 of FIG. 10. In some embodiments, the process of FIG. 11 is performed using a lidar system such as lidar system 100 as shown in FIGS. 1-4 and 6. In some embodiments, the process is performed at least in part by a controller of a lidar system such as controller 150 of lidar system 100 as shown in FIGS. 1 and 6 and/or one or more processors associated with the lidar system.

At 1101, a seed geometric face is selected. For example, a geometric face of the three-dimensional geometric mesh is selected based on properties of the geometric faces, such as their normal vectors, their heights, their distance from the lidar device, etc. In various embodiments, a variety of selection criteria can be utilized and configured depending on the desired outcome. In some embodiments, the face with the lowest height is selected as a seed geometric face. For example, the heights of candidate faces are determined and the face with the lowest height is selected as a seed geometric face. In various embodiments, the height of a face can be determined based on the corresponding altitude values for the face vertices. In some embodiments, the face height is the average, mean, median, minimum, maximum, or another calculated height value determined using at least one of the height (or altitude) values of the vertices of the face. In some embodiments, the seed is selected based on other properties such as the distance of the face from the lidar device. For example, a seed can be selected based on the face closest to the lidar device and/or the vehicle equipped with the lidar device. In some embodiments, seed faces can be selected for locations corresponding to in front of, to the sides of, behind, and/or beneath the vehicle. In addition, in some embodiments, the normal of a face is used in selecting a seed. For example, the normal of candidate faces can be determined and each determined face normal is compared to a reference axis, such as the Z-axis of the lidar device or lidar sensor, to select the seed face. In various embodiments, the seed is selected from a subdivided region of the geometric mesh. For example, one or more seed faces can be selected from each subdivided region. In some embodiments, multiple seed geometric faces are utilized and the process of FIG. 11 is performed for each selected seed. In various embodiments, the selected seed face is the initial face included in the region group.

At 1103, a neighboring geometric face is selected. For example, a geometric face that is a neighbor of (or borders) a previously evaluated face selected for inclusion in the region group is selected for evaluation as a candidate to include in the region group. In various embodiments, any of the unevaluated neighboring faces of a previous candidate face included in the region group can be selected. During the initial iterations of the selection process, the selected neighboring faces may be limited to faces of the selected seed face. However, as additional faces are included in the region group, the neighboring faces can be selected from unevaluated neighbors of any of the faces added to the region group. In this manner, the selection of neighboring faces over different iterations corresponds to an outward expansion of faces starting with the seed face. In some embodiments, the neighboring geometric face is selected using a flood selection criterion. For example, the selection process expands from the seed face to iteratively evaluate all neighboring faces of evaluated faces included in the region group.

At 1105, a determination is made whether the selected neighboring face meets selection criteria. In the event the face meets selection criteria, processing proceeds to 1107 where the face is included in the region group. In the event the face does not meet selection criteria, processing proceeds to 1109 where the face is excluded from the region group. In various embodiments, the relative neighbor selection criteria are based on properties of the selected neighboring face and can be further based on other faces already included in the region group including the seed face. For example, the relative neighbor selection criteria may include evaluating the result from comparing the determined normal of the selected neighboring face to a normal of a reference geometric face of the geometric mesh, such as the selected seed geometric face or another geometric face included in the region group including neighboring faces. In some embodiments, the relative neighbor selection criteria include evaluating the result from comparing the determined normal of the selected neighboring face to a normal of a reference axis such as an axis (such as the Z-axis) of the lidar device or the vehicle equipped with the lidar device.

At 1107, the selected neighboring geometric face is included in the region group. For example, the neighboring face selected at 1103 meets selection criteria and is included in the region group. Moreover, the included face may now be used on subsequent iterations of step 1103 to select future candidate faces. In some embodiments, properties of the included face are determined as part of including the face in the region group. For example, for drivable (or operable) faces, drivable characteristics including a drivable coefficient can be determined for the included face and its vertices. In various embodiments, a drivable characteristic is associated with the face and/or at least one vertex of the geometric face included in the region group.

At 1109, the selected neighboring geometric face is excluded from the region group. For example, the neighboring face selected at 1103 does not meet the selection criteria and is excluded from the region group. The excluded face is not used on subsequent iterations of step 1103 to select future candidate faces.

At 1111, a determination is made whether additional unevaluated neighboring faces exist. In the event additional unevaluated neighbors exist, processing loops back to 1103 where an unevaluated neighboring face is analyzed for potential selection into the region group. In the event additional unevaluated neighbors do not exist, processing proceeds to 1113.

At 1113, the completed region with determined region properties is provided. For example, the region group and its faces and vertices are provided. In some embodiments, the properties associated with the region group are also provided including whether the region is a drivable (or operable) or non-drivable region. The provided properties associated with the region group can include drivable characteristics and are associated with at least one vertex and/or at least one geometric face of the completed region. In some embodiments, as part of providing the completed region, the grouping of faces in the region is refined, for example, to improve the accuracy of the group. In some embodiments, the refinement process reduces noise, for example, by removing irregular or noisy faces from the region group. In various embodiments, the refinement process may utilize consensus-based methods such as one or more consensus-based methods to exclude a previously included face from the region group and/or to include a previously excluded face in the region group.

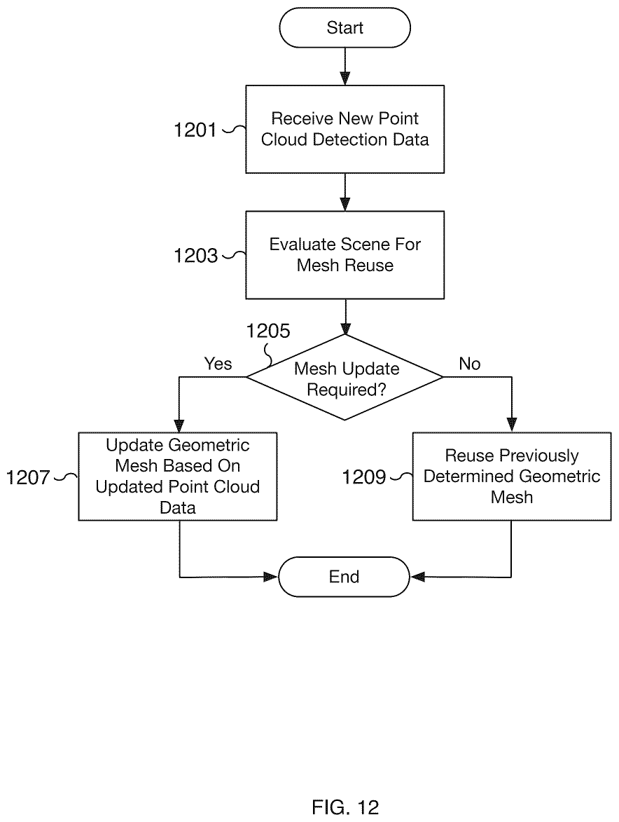

FIG. 12 is a flow chart illustrating an embodiment of a process for updating a geometric mesh for estimating the surface of a surrounding environment. For example, using the process of FIG. 12, new detection data such as refreshed point cloud detection data measured via a lidar device is used to determine whether an existing three-dimensional geometric mesh can be reused. Based on the changes identified by analyzing the new detection data compared to existing detection data, a new three-dimensional geometric mesh can be regenerated, or the existing three-dimensional geometric mesh or portions of the existing three-dimensional geometric mesh can be reused. In various embodiments, the reuse of existing geometric mesh data significantly improves the performance in generating an accurate geometric mesh for estimating the surface of a surrounding environment. In some embodiments, the process of FIG. 12 is performed at 805 and/or 807 of FIG. 8 such as when new detection data is available. In some embodiments, the process of FIG. 12 allows for the reuse of region grouping results determined for the geometric faces and vertices of a geometric mesh. For example, the reuse of a geometric mesh or portions of a geometric mesh allows for portions of step 807 of FIG. 8 to be skipped. In some embodiments, the process of FIG. 12 is performed using a lidar system such as lidar system 100 as shown in FIGS. 1-4 and 6. In some embodiments, the process is performed at least in part by a controller of a lidar system such as controller 150 of lidar system 100 as shown in FIGS. 1 and 6 and/or one or more processors associated with the lidar system.

At 1201, new point cloud detection data is received. For example, the detection data captured by a lidar device is updated and the newly received measurement data is received. In some embodiments, the data is provided as an updated point cloud. For example, existing point data is updated to reflect the current position and orientation of the lidar device and/or vehicle with the lidar device installed as well as the updated environment surrounding the lidar device. Based on the newly received detection data, existing points of the point cloud may have shifted with respect to the lidar system. In some embodiments, the detection data is provided via a different format distinct from a point cloud, such as a set of delta detection data results.

At 1203, the surrounding scene is evaluated for mesh reuse. For example, the surrounding environment is evaluated to determine whether the underlying changes in the scene meet a change threshold that requires the geometric mesh or portions of the geometric mesh to be reconstructed. In the event the change threshold is not met, the existing and previously generated geometric mesh still accurately reflects and estimates the surrounding surface environment and can be reused. In some embodiments, only portions of the existing mesh can be reused and certain portions meet a change threshold and require updating.

In some embodiments, the change threshold is determined by analyzing the difference between previously received detection data and the new detection data received at 1201. For example, each point or vertex of the mesh (or corresponding pixel of the point cloud) can be analyzed to determine whether its location has changed and by how much. In some embodiments, a change threshold is met based on the number of points that have changed by a certain threshold amount. For example, a change in a certain percentage (such as 5%, 10%, 15% or another threshold amount) of points by more than a configured number of degrees in azimuth or altitude can require that the mesh be updated. In some embodiments, the change threshold is configurable and dependent on the surface region. For example, certain regions may require a lower change threshold (or very minimal changes) to initiate the reconstruction of the region's mesh. Other regions may allow for a higher change threshold (or a greater number of changes) before the region requires reconstruction. For example, regions that are inaccessible from the vehicle may allow for a higher change threshold. In some embodiments, the change threshold is dynamically adjusted and can change based on parameters such as vehicle speed, weather conditions, visibility, confidence level, detected objects in the environment, etc. For example, the change threshold may change dynamically based on how fast the vehicle is moving or whether pedestrians or vehicles are detected nearby.

At 1205, a determination is made whether the geometric mesh requires an update. In the event the geometric mesh requires an update, processing proceeds to 1207. In the event the geometric mesh does not require an update, processing proceeds to 1209.

At 1207, the geometric mesh is updated based on updated point cloud data. For example, a new three-dimensional geometric mesh is generated based on the updated point cloud detection data including updated azimuth, altitude, and distance measurements. In some embodiments, the update is performed for only a portion of the geometric mesh and portions of the mesh corresponding to portions of the scene that have not met the change threshold are not updated. For example, when travelling at certain speeds, portions of the geometric mesh corresponding to regions near the horizon or in the distance are unlikely to change as frequently as regions near the vehicle. Correspondingly, regions of the geometric mesh near the vehicle may be updated more frequently and reused less frequently.

At 1209, a previously determined geometric mesh is reused. For example, the changes in the scene have not met a change threshold and the existing geometric mesh still accurately reflects the surrounding surface environment. Consequently, the previously determined geometric mesh is reused. In some embodiments, characteristics assigned to the faces and vertices of the mesh are also reused, such as drivability determinations and drivable coefficients. In some embodiments, the existing two-dimensional mesh is reused but values for the third dimension are updated using new detection data. For example, distance (or range) measurements may be updated for the three-dimensional geometric mesh while preserving the underlying two-dimensional geometric mesh and the assignment of vertices to faces within the mesh.

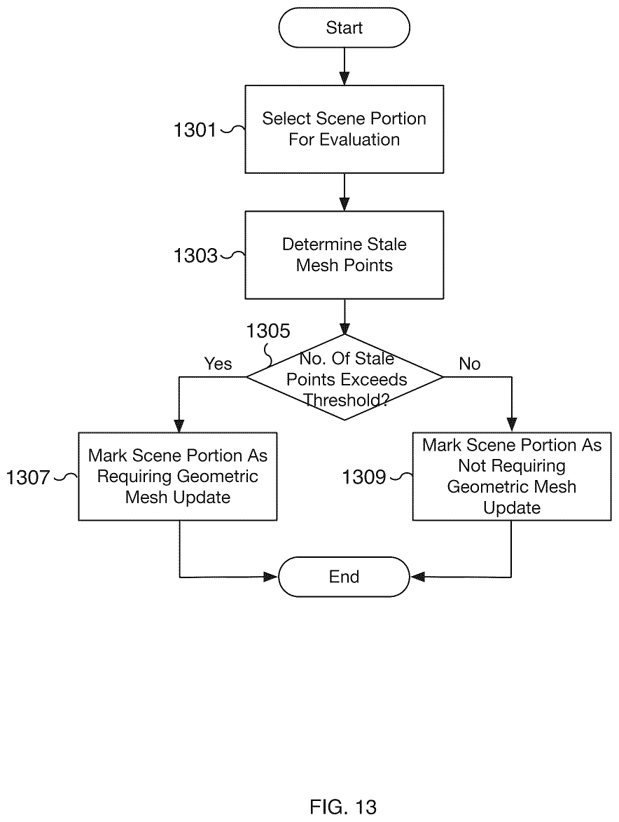

FIG. 13 is a flow chart illustrating an embodiment of a process for evaluating the change in a scene to determine mesh reuse. For example, using the process of FIG. 13, the surrounding scene can be evaluated to determine whether an existing geometric mesh still accurately estimates the surrounding surface. In some embodiments, the process of FIG. 13 determines whether a change threshold has been met to require a region of the geometric mesh to be reconstructed or whether a change threshold has not been met and a region of the geometric mesh can be reused. In some embodiments, the process of FIG. 13 is applied to an entire geometric mesh, a region group of a geometric mesh, and/or a sub-section of the geometric mesh. In some embodiments, the process of FIG. 13 is performed at 805 and/or 807 of FIG. 8 and/or at 1203 of FIG. 12. In some embodiments, the process of FIG. 13 is performed using a lidar system such as lidar system 100 as shown in FIGS. 1-4 and 6. In some embodiments, the process is performed at least in part by a controller of a lidar system such as controller 150 of lidar system 100 as shown in FIGS. 1 and 6 and/or one or more processors associated with the lidar system.

At 1301, a portion of the scene is selected for evaluation. For example, a scene portion such as a portion of the geometric mesh or corresponding point cloud is selected for evaluation to determine mesh reuse. In some embodiments, the portion selected can correspond to the entire geometric mesh and can result in regenerating the entire mesh or reusing the entire mesh. In some embodiments, the portion selected corresponds to a sub-section of the geometric mesh or a region group and only the evaluated portion may require regeneration or may be reused. In various embodiments, different portions of the scene can be selected based on the desired outcome. For example, portions directly ahead of the vehicle can be selected at higher rates for evaluation compared to portions corresponding to the horizon or surfaces that are far away or inaccessible. In some embodiments, the portion of the scene is selected based on its location in the scene, such as near the lidar device or vehicle, at the horizon, or another location parameter. For example, a portion of the geometric mesh can be selected that corresponds to a near region or a horizon region. In various embodiments, the portion is selected based on the two-dimensional geometric mesh, the three-dimensional geometric mesh, and/or a corresponding point cloud. In some embodiments, the portion is selected based on altitude values of vertices of the geometric mesh. For example, points corresponding to a portion of the scene above or below a certain height or altitude can be selected. In some embodiments, the portion is selected based on azimuth values of vertices of the geometric mesh. For example, a portion of the scene corresponding to a narrow region directly ahead of the vehicle, directly behind the vehicle, or corresponding to one of the vehicle's blind spots can be selected based on at least the azimuth values of vertices.

At 1303, stale mesh points are determined. For example, the points corresponding to the portion of the scene selected at 1301 are evaluated to determine whether each point is stale and no longer valid. Stale points can be determined by analyzing the difference between previously received detection data and the newly received detection data for the point. For example, a point in the point cloud may have moved by a certain amount sufficient to invalidate the accuracy of the previous detection data. In various embodiments, the number of stale mesh points is tracked, and the total number of stale points is determined for the selected region.

At 1305, a determination is made whether the number of stale points exceeds a threshold amount. In the event the number of stale points exceeds a threshold amount, processing proceeds to 1307. In the event the number of stale points does not exceed a threshold amount, processing proceeds to 1309 where the corresponding portion of the mesh can be reused. In various embodiments, the threshold amount may change dynamically based on properties associated with the surrounding environment, scene, and/or lidar device. Example properties can include vehicle speed, weather conditions, visibility, confidence level, detected objects in the environment, etc. For example, the threshold amount may change dynamically based on how fast the vehicle is moving or whether pedestrians or vehicles are detected nearby.

At 1307, the scene portion is marked as requiring a geometric mesh update. For example, based on the number of stale points and/or the percentage of stale points relative to the total number of points in the selected portion of the scene, the portion of the geometric mesh corresponding to the selected scene portion requires updating and the portion is marked for reconstruction. In various embodiments, based on the determination that reconstruction is necessary, a new portion of the mesh corresponding to at least the selected portion will be regenerated.

At 1309, the scene portion is marked as not requiring a geometric mesh update. For example, the portion of the geometric mesh corresponding to the selected scene portion still accurately estimates or represents the corresponding surface environment. Based on the determination at 1305, the corresponding portion of the geometric mesh can be reused and no update for the portion is required. In some embodiments, the properties associated with the reused faces and/or vertex points of the mesh portion are also reused.

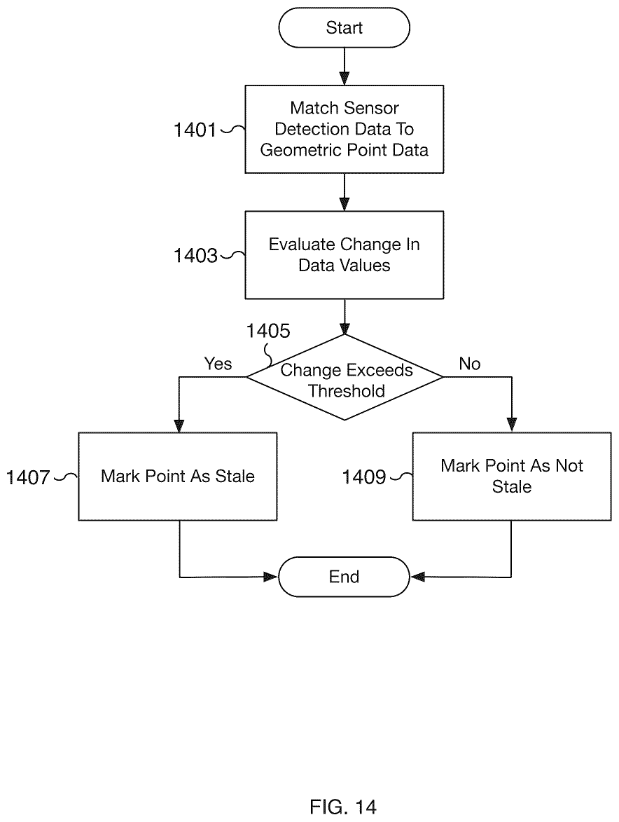

FIG. 14 is a flow chart illustrating an embodiment of a process for evaluating the change in a point of a scene to determine mesh reuse. For example, using the process of FIG. 14, a point associated with the surrounding scene can be evaluated to determine whether the point represented in an existing geometric mesh still accurately estimates the surrounding surface. In some embodiments, the process of FIG. 14 determines whether a change threshold associated with a point of the geometric mesh has been met to invalidate the accuracy of the point by marking the point as stale and requiring updating. In some embodiments, the process of FIG. 14 is applied to the vertices of an existing geometric mesh when a region of the mesh is evaluated for reuse. In some embodiments, the process of FIG. 14 is performed at 805 and/or 807 of FIG. 8, at 1203 of FIG. 12, and/or at 1305 of FIG. 13. In some embodiments, the process of FIG. 14 is performed using a lidar system such as lidar system 100 as shown in FIGS. 1-4 and 6. In some embodiments, the process is performed at least in part by a controller of a lidar system such as controller 150 of lidar system 100 as shown in FIGS. 1 and 6 and/or one or more processors associated with the lidar system.

At 1401, sensor detection data is matched to geometric point data. For example, newly received lidar detection data such as updated azimuth and altitude values are matched to corresponding data values used by the corresponding geometric point of an existing geometric mesh. In some embodiments, the matched data uses horizontal and vertical values rather than angular azimuth and altitude values. In some embodiments, the matched data includes matching distance values for the point being evaluated.

At 1403, the change in data values is evaluated. For example, the difference between previous detection data and current sensor detection data is analyzed. In various embodiments, the difference between previous and current values for a point's azimuth and altitude values are determined. For example, the determined change can correspond to the change in azimuth and/or altitude values for a point corresponding to a vertex of an existing two-dimensional geometric mesh. In some embodiments, the difference between the previous and current values for a point's distance value is also determined. For example, the determined change can correspond to the change in azimuth, altitude, and/or distance values for a point corresponding to a vertex of an existing three-dimensional geometric mesh. For angular data values, such as for angular azimuth and altitude values, the difference can be measured by the change in radians.

In some embodiments, once the differences in data values are determined, the changes are compared to configured threshold values. In particular embodiments, the configured threshold values are based on the density, precision, and/or other properties of the lidar system and/or the desired use for the geometric mesh. For example, for regions scanned at a higher density and that require high precision, the threshold value to invalidate a point may be lower. Conversely, for regions scanned at a lower density and that require low precision, the threshold value to invalidate a point may be higher. In some embodiments, the threshold value for invalidating a point can be configured based on the lidar's beam-to-beam distance. For example, a threshold value can correspond to a threshold change in radians between previous and current values. A configured threshold value can be a radian amount based on the beam-to-beam distance of the lidar device.

At 1405, a determination is made whether the evaluated change exceeds a threshold value. In the event the change exceeds a threshold value, processing proceeds to 1407 where the point is invalidated. In the event the change does not exceed a threshold value, processing proceeds to 1409. In various embodiments, the threshold value is configurable and can change dynamically, for example, based on properties of the lidar system, vehicle, surrounding environment, and past evaluation results, among other factors.

At 1407, the point is marked as stale. For example, the point is marked as stale to indicate that its accuracy is no longer valid, and the corresponding point data and associated geometric mesh needs to be updated. In some embodiments, once a point is marked as stale, the corresponding geometric faces that include the point are also marked as stale and the region of the marked faces is designated for regeneration using the latest sensor detection data.

At 1409, the point is not marked as stale. For example, the point and its corresponding point data are still valid and accurate for estimating the corresponding surface region that includes the point. In various embodiments, when the points or vertices of a geometric face are not marked as stale, the corresponding two-dimensional mesh face is reused. In some embodiments, the corresponding three-dimensional mesh face is reused. In some embodiments, only the corresponding two-dimensional mesh data points are reused, and the third dimension is updated using the distance measurement from the latest lidar detection data.

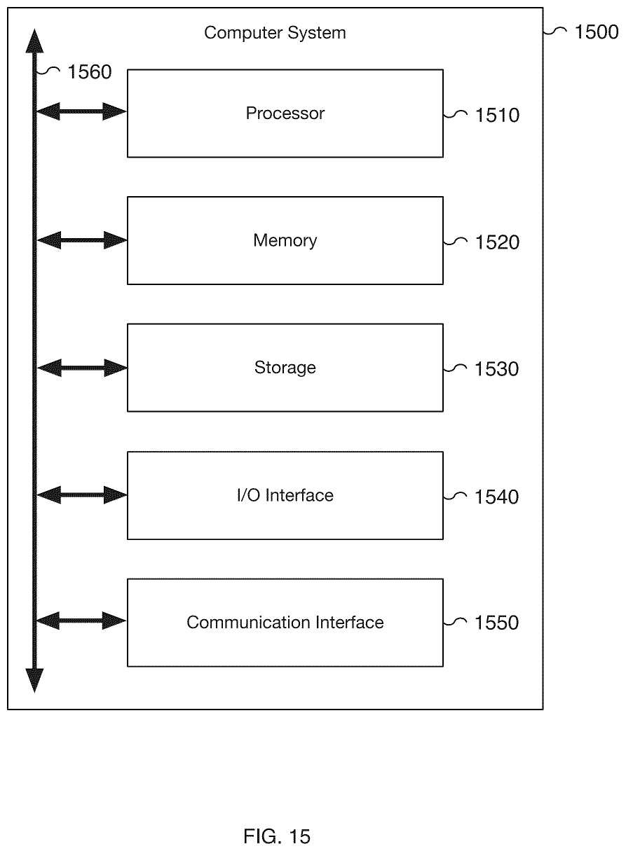

FIG. 15 illustrates an example computer system 1500. In particular embodiments, one or more computer systems 1500 may perform one or more steps of one or more methods described or illustrated herein. In particular embodiments, one or more computer systems 1500 may provide functionality described or illustrated herein. In particular embodiments, software running on one or more computer systems 1500 may perform one or more steps of one or more methods described or illustrated herein or may provide functionality described or illustrated herein. Particular embodiments may include one or more portions of one or more computer systems 1500. In particular embodiments, a computer system may be referred to as a processor, a controller, a computing device, a computing system, a computer, a general-purpose computer, or a data-processing apparatus. Herein, reference to a computer system may encompass one or more computer systems, where appropriate.

Computer system 1500 may take any suitable physical form. As an example, computer system 1500 may be an embedded computer system, a system-on-chip (SOC), a single-board computer system (SBC), a desktop computer system, a laptop or notebook computer system, a mainframe, a mesh of computer systems, a server, a tablet computer system, or any suitable combination of two or more of these. As another example, all or part of computer system 1500 may be combined with, coupled to, or integrated into a variety of devices, including, but not limited to, a camera, camcorder, personal digital assistant (PDA), mobile telephone, smartphone, electronic reading device (e.g., an e-reader), game console, smart watch, clock, calculator, television monitor, flat-panel display, computer monitor, vehicle display (e.g., odometer display or dashboard display), vehicle navigation system, lidar system, ADAS, autonomous vehicle, autonomous-vehicle driving system, cockpit control, camera view display (e.g., display of a rear-view camera in a vehicle), eyewear, or head-mounted display. Where appropriate, computer system 1500 may include one or more computer systems 1500; be unitary or distributed; span multiple locations; span multiple machines; span multiple data centers; or reside in a cloud, which may include one or more cloud components in one or more networks. Where appropriate, one or more computer systems 1500 may perform without substantial spatial or temporal limitation one or more steps of one or more methods described or illustrated herein. As an example, one or more computer systems 1500 may perform in real time or in batch mode one or more steps of one or more methods described or illustrated herein. One or more computer systems 1500 may perform at different times or at different locations one or more steps of one or more methods described or illustrated herein, where appropriate.

As illustrated in the example of FIG. 15, computer system 1500 may include a processor 1510, memory 1520, storage 1530, an input/output (I/O) interface 1540, a communication interface 1550, or a bus 1560. Computer system 1500 may include any suitable number of any suitable components in any suitable arrangement.

In particular embodiments, processor 1510 may include hardware for executing instructions, such as those making up a computer program. As an example, to execute instructions, processor 1510 may retrieve (or fetch) the instructions from an internal register, an internal cache, memory 1520, or storage 1530; decode and execute them; and then write one or more results to an internal register, an internal cache, memory 1520, or storage 1530. In particular embodiments, processor 1510 may include one or more internal caches for data, instructions, or addresses. Processor 1510 may include any suitable number of any suitable internal caches, where appropriate. As an example, processor 1510 may include one or more instruction caches, one or more data caches, or one or more translation lookaside buffers (TLBs). Instructions in the instruction caches may be copies of instructions in memory 1520 or storage 1530, and the instruction caches may speed up retrieval of those instructions by processor 1510. Data in the data caches may be copies of data in memory 1520 or storage 1530 for instructions executing at processor 1510 to operate on; the results of previous instructions executed at processor 1510 for access by subsequent instructions executing at processor 1510 or for writing to memory 1520 or storage 1530; or other suitable data. The data caches may speed up read or write operations by processor 1510. The TLBs may speed up virtual-address translation for processor 1510. In particular embodiments, processor 1510 may include one or more internal registers for data, instructions, or addresses. Processor 1510 may include any suitable number of any suitable internal registers, where appropriate. Where appropriate, processor 1510 may include one or more arithmetic logic units (ALUs); may be a multi-core processor; or may include one or more processors 1510.

In particular embodiments, memory 1520 may include main memory for storing instructions for processor 1510 to execute or data for processor 1510 to operate on. As an example, computer system 1500 may load instructions from storage 1530 or another source (such as, for example, another computer system 1500) to memory 1520. Processor 1510 may then load the instructions from memory 1520 to an internal register or internal cache. To execute the instructions, processor 1510 may retrieve the instructions from the internal register or internal cache and decode them. During or after execution of the instructions, processor 1510 may write one or more results (which may be intermediate or final results) to the internal register or internal cache. Processor 1510 may then write one or more of those results to memory 1520. One or more memory buses (which may each include an address bus and a data bus) may couple processor 1510 to memory 1520. Bus 1560 may include one or more memory buses. In particular embodiments, one or more memory management units (MMUs) may reside between processor 1510 and memory 1520 and facilitate accesses to memory 1520 requested by processor 1510. In particular embodiments, memory 1520 may include random access memory (RAM). This RAM may be volatile memory, where appropriate. Where appropriate, this RAM may be dynamic RAM (DRAM) or static RAM (SRAM). Memory 1520 may include one or more memories 1520, where appropriate.

In particular embodiments, storage 1530 may include mass storage for data or instructions. As an example, storage 1530 may include a hard disk drive (HDD), a floppy disk drive, flash memory, an optical disc, a magneto-optical disc, magnetic tape, or a Universal Serial Bus (USB) drive or a combination of two or more of these. Storage 1530 may include removable or non-removable (or fixed) media, where appropriate. Storage 1530 may be internal or external to computer system 1500, where appropriate. In particular embodiments, storage 1530 may be non-volatile, solid-state memory. In particular embodiments, storage 1530 may include read-only memory (ROM). Where appropriate, this ROM may be mask ROM (MROM), programmable ROM (PROM), erasable PROM (EPROM), electrically erasable PROM (EEPROM), flash memory, or a combination of two or more of these. Storage 1530 may include one or more storage control units facilitating communication between processor 1510 and storage 1530, where appropriate. Where appropriate, storage 1530 may include one or more storages 1530.

In particular embodiments, I/O interface 1540 may include hardware, software, or both, providing one or more interfaces for communication between computer system 1500 and one or more I/O devices. Computer system 1500 may include one or more of these I/O devices, where appropriate. One or more of these I/O devices may enable communication between a person and computer system 1500. As an example, an I/O device may include a keyboard, keypad, microphone, monitor, mouse, printer, scanner, speaker, camera, stylus, tablet, touch screen, trackball, another suitable I/O device, or any suitable combination of two or more of these. An I/O device may include one or more sensors. Where appropriate, I/O interface 1540 may include one or more device or software drivers enabling processor 1510 to drive one or more of these I/O devices. I/O interface 1540 may include one or more I/O interfaces 1540, where appropriate.

In particular embodiments, communication interface 1550 may include hardware, software, or both providing one or more interfaces for communication (such as, for example, packet-based communication) between computer system 1500 and one or more other computer systems 1500 or one or more networks. As an example, communication interface 1550 may include a network interface controller (NIC) or network adapter for communicating with an Ethernet or other wire-based network or a wireless NIC (WNIC); a wireless adapter for communicating with a wireless network, such as a WI-FI network; or an optical transmitter (e.g., a laser or a light-emitting diode) or an optical receiver (e.g., a photodetector) for communicating using fiber-optic communication or free-space optical communication. Computer system 1500 may communicate with an ad hoc network, a personal area network (PAN), an in-vehicle network (IVN), a local area network (LAN), a wide area network (WAN), a metropolitan area network (MAN), or one or more portions of the Internet or a combination of two or more of these. One or more portions of one or more of these networks may be wired or wireless. As an example, computer system 1500 may communicate with a wireless PAN (WPAN) (such as, for example, a BLUETOOTH WPAN), a WI-FI network, a Worldwide Interoperability for Microwave Access (WiMAX) network, a cellular telephone network (such as, for example, a Global System for Mobile Communications (GSM) network), or other suitable wireless network or a combination of two or more of these. As another example, computer system 1500 may communicate using fiber-optic communication based on 100 Gigabit Ethernet (100 GbE), 10 Gigabit Ethernet (10 GbE), or Synchronous Optical Networking (SONET). Computer system 1500 may include any suitable communication interface 1550 for any of these networks, where appropriate. Communication interface 1550 may include one or more communication interfaces 1550, where appropriate.

In particular embodiments, bus 1560 may include hardware, software, or both coupling components of computer system 1500 to each other. As an example, bus 1560 may include an Accelerated Graphics Port (AGP) or other graphics bus, a controller area network (CAN) bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local bus (VLB), or another suitable bus or a combination of two or more of these. Bus 1560 may include one or more buses 1560, where appropriate.

In particular embodiments, various modules, circuits, systems, methods, or algorithm steps described in connection with the implementations disclosed herein may be implemented as electronic hardware, computer software, or any suitable combination of hardware and software. In particular embodiments, computer software (which may be referred to as software, computer-executable code, computer code, a computer program, computer instructions, or instructions) may be used to perform various functions described or illustrated herein, and computer software may be configured to be executed by or to control the operation of computer system 1500. As an example, computer software may include instructions configured to be executed by processor 1510. In particular embodiments, owing to the interchangeability of hardware and software, the various illustrative logical blocks, modules, circuits, or algorithm steps have been described generally in terms of functionality. Whether such functionality is implemented in hardware, software, or a combination of hardware and software may depend upon the particular application or design constraints imposed on the overall system.

In particular embodiments, a computing device may be used to implement various modules, circuits, systems, methods, or algorithm steps disclosed herein. As an example, all or part of a module, circuit, system, method, or algorithm disclosed herein may be implemented or performed by a general-purpose single-or multi-chip processor, a digital signal processor (DSP), an ASIC, a FPGA, any other suitable programmable-logic device, discrete gate or transistor logic, discrete hardware components, or any suitable combination thereof. A general-purpose processor may be a microprocessor, or, any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

In particular embodiments, one or more implementations of the subject matter described herein may be implemented as one or more computer programs (e.g., one or more modules of computer-program instructions encoded or stored on a computer-readable non-transitory storage medium). As an example, the steps of a method or algorithm disclosed herein may be implemented in a processor-executable software module which may reside on a computer-readable non-transitory storage medium. In particular embodiments, a computer-readable non-transitory storage medium may include any suitable storage medium that may be used to store or transfer computer software and that may be accessed by a computer system. Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs (e.g., compact discs (CDs), CD-ROM, digital versatile discs (DVDs), blu-ray discs, or laser discs), optical disc drives (ODDs), magneto-optical discs, magneto-optical drives, floppy diskettes, floppy disk drives (FDDs), magnetic tapes, flash memories, solid-state drives (SSDs), RAM, RAM-drives, ROM, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

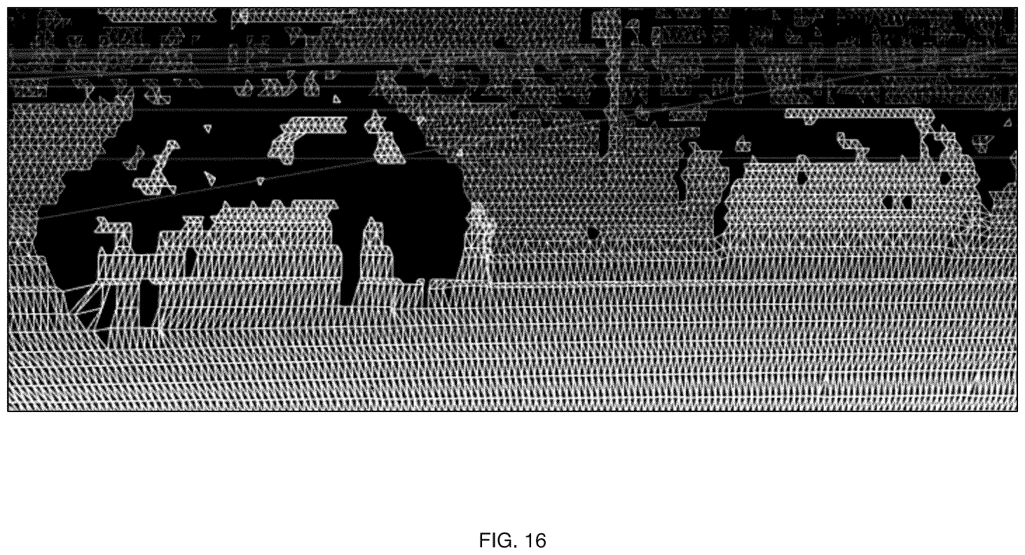

FIG. 16 is a diagram illustrating a visual example of a two-dimensional flat geometric mesh determined using lidar sensor detection data. In the example shown, FIG. 16 is a portion of a flat geometric mesh determined using lidar sensor data. The corresponding flat geometric mesh is a two-dimensional triangle mesh where the vertices of the mesh correspond to lidar point data. For example, in various embodiments, the two axes of the vertices of the mesh correspond to azimuth and altitude values with respect to the lidar system. In some embodiments, the axes correspond to horizontal and vertical values. In various embodiments, the geometric faces of the two-dimensional flat geometric mesh are determined by triangulating a set of points based on the lidar sensor detection data. In some embodiments, the process is performed using the techniques described herein including the steps performed at step 805 of FIG. 8 and step 903 of FIG. 9. As further described herein, based on the determined two-dimensional flat geometric mesh, a three-dimensional geometric mesh can be generated that includes the lidar distance measurements. The generated three-dimensional geometric mesh estimates the surface of the surrounding environment and can be further analyzed to determine properties associated with different regions of the geometric mesh including drivable characteristics. In some embodiments, the two-dimensional flat geometric mesh of FIG. 16 is determined using a lidar system such as lidar system 100 as shown in FIGS. 1-4 and 6. In some embodiments, the process for determining the mesh is performed at least in part by a controller of a lidar system such as controller 150 of lidar system 100 as shown in FIGS. 1 and 6 and/or one or more processors associated with the lidar system.

In particular embodiments, certain features described herein in the context of separate implementations may also be combined and implemented in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variations of a sub-combination.

While operations may be depicted in the drawings as occurring in a particular order, this should not be understood as requiring that such operations be performed in the particular order shown or in sequential order, or that all operations be performed. Further, the drawings may schematically depict one more example processes or methods in the form of a flow diagram or a sequence diagram. However, other operations that are not depicted may be incorporated in the example processes or methods that are schematically illustrated. For example, one or more additional operations may be performed before, after, simultaneously with, or between any of the illustrated operations. Moreover, one or more operations depicted in a diagram may be repeated, where appropriate. Additionally, operations depicted in a diagram may be performed in any suitable order. Furthermore, although particular components, devices, or systems are described herein as carrying out particular operations, any suitable combination of any suitable components, devices, or systems may be used to carry out any suitable operation or combination of operations. In certain circumstances, multitasking or parallel processing operations may be performed. Moreover, the separation of various system components in the implementations described herein should not be understood as requiring such separation in all implementations, and it should be understood that the described program components and systems may be integrated together in a single software product or packaged into multiple software products.

Various embodiments have been described in connection with the accompanying drawings. However, it should be understood that the figures may not necessarily be drawn to scale. As an example, distances or angles depicted in the figures are illustrative and may not necessarily bear an exact relationship to actual dimensions or layouts of the devices illustrated.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes or illustrates respective embodiments herein as including particular components, elements, functions, operations, or steps, any of these embodiments may include any combination or permutation of any of the components, elements, functions, operations, or steps described or illustrated anywhere herein that a person having ordinary skill in the art would comprehend.

The term “or” as used herein is to be interpreted as an inclusive or meaning any one or any combination, unless expressly indicated otherwise or indicated otherwise by context. Therefore, herein, the expression “A or B” means “A, B, or both A and B.” As another example, herein, “A, B or C” means at least one of the following: A; B; C; A and B; A and C; B and C; A, B and C. An exception to this definition will occur if a combination of elements, devices, steps, or operations is in some way inherently mutually exclusive.

As used herein, words of approximation such as, without limitation, “approximately, “substantially,” or “about” refer to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skill in the art recognize the modified feature as having the required characteristics or capabilities of the unmodified feature. In general, but subject to the preceding discussion, a numerical value herein that is modified by a word of approximation such as “approximately” may vary from the stated value by ±0.5%, ±1%, ±2%, ±3%, ±4%, ±5%, ±10%, ±12%, or ±15%. The term “substantially constant” refers to a value that varies by less than a particular amount over any suitable time interval. For example, a value that is substantially constant may vary by less than or equal to 20%, 10%, 1%, 0.5%, or 0.1% over a time interval of approximately 10⁴ s, 10³ s, 10² s, 10 s, 1 s, 100 ms, 10 ms, 1 ms, 100 μs, 10 μs, or 1 μs. The term “substantially constant” may be applied to any suitable value, such as for example, an optical power, a pulse repetition frequency, an electrical current, a wavelength, an optical or electrical frequency, or an optical or electrical phase.

As used herein, the terms “first,” “second,” “third,” etc. may be used as labels for nouns that they precede, and these terms may not necessarily imply a particular ordering (e.g., a particular spatial, temporal, or logical ordering). As an example, a system may be described as determining a “first result” and a “second result,” and the terms “first” and “second” may not necessarily imply that the first result is determined before the second result.

As used herein, the terms “based on” and “based at least in part on” may be used to describe or present one or more factors that affect a determination, and these terms may not exclude additional factors that may affect a determination. A determination may be based solely on those factors which are presented or may be based at least in part on those factors. The phrase “determine A based on B” indicates that B is a factor that affects the determination of A. In some instances, other factors may also contribute to the determination of A. In other instances, A may be determined based solely on B.

Although the foregoing embodiments have been described in some detail for purposes of clarity of understanding, the invention is not limited to the details provided. There are many alternative ways of implementing the invention. The disclosed embodiments are illustrative and not restrictive.

WHAT IS CLAIMED IS:

1. A method, comprising:
receiving a point cloud generated at least in part using a lidar sensor;
determining a geometric mesh based on the point cloud;
selecting a seed geometric face formed in the geometric mesh based on one or more seed selection criteria;
starting from the seed geometric face, iteratively selecting neighboring geometric faces of the geometric mesh that meet one or more relative neighbor selection criteria into a region group; and
detecting an operable region indicated by the region group.

2. The method of claim 1, wherein the geometric mesh is generated based on a two-dimensional flat geometric mesh.

3. The method of claim 2, wherein the two-dimensional flat geometric mesh is determined based on azimuth and altitude values of the point cloud.

4. The method of claim 2, wherein the two-dimensional flat geometric mesh is determined independent from distance values associated with the point cloud.

5. The method of claim 1, wherein the geometric mesh is a three-dimensional mesh, and wherein the geometric mesh includes azimuth, altitude, and distance dimensions.

6. The method of claim 1, wherein the geometric mesh includes a plurality of triangles, wherein each vertex of the plurality of triangles corresponds to a point of the point cloud.

7. The method of claim 1, wherein the one or more seed selection criteria includes determining a normal of a geometric face of the geometric mesh and comparing the normal to a reference axis of the lidar sensor.

8. The method of claim 1, wherein selecting the seed geometric face formed in the geometric mesh based on the one or more seed selection criteria includes determining a height for a candidate geometric face.

9. The method of claim 8, wherein the height for the candidate geometric face is based on a corresponding altitude value for each vertex of the candidate geometric face.

10. The method of claim 1, wherein the one or more relative neighbor selection criteria includes determining a normal of a geometric face of the geometric mesh.

11. The method of claim 10, further comprising comparing the normal of the geometric face of the geometric mesh to a reference axis.

12. The method of claim 10, further comprising comparing the normal of the geometric face of the geometric mesh to a normal of a reference geometric face.

13. The method of claim 12, wherein the reference geometric face is included in the seed geometric face.

14. The method of claim 1, wherein the detected operable region is associated with a drivable surface.

15. The method of claim 1, further comprising associating a drivable characteristic with at least one vertex of the geometric mesh.

16. The method of claim 1, further comprising associating a drivable characteristic with at least one geometric face of the geometric mesh.

17. The method of claim 1, further comprising removing a face from the geometric mesh based on a property of the face.

18. The method of claim 17, wherein the property of the face is a length of an edge of the face, an area of the face, an intensity value associated with the face, or a value of an angle of the face.

19. A system, comprising:
a lidar sensor to provide one or more measurements of targets located downrange from the system;
one or more processors; and
a memory coupled to the one or more processors, wherein the memory is configured to provide the one or more processors with instructions which when executed cause the one or more processors to:
receive a point cloud generated at least in part using the lidar sensor;
determine a geometric mesh based on the point cloud;
select a seed geometric face formed in the geometric mesh based on one or more seed selection criteria;
starting from the seed geometric face, iteratively select neighboring geometric faces of the geometric mesh that meet one or more relative neighbor selection criteria into a region group; and
detect an operable region indicated by the region group.

20. A computer program product, the computer program product being embodied in a non-transitory computer readable storage medium and comprising computer instructions for:
receiving a point cloud generated at least in part using a lidar sensor;
determining a geometric mesh based on the point cloud;
selecting a seed geometric face formed in the geometric mesh based on one or more seed selection criteria;
starting from the seed geometric face, iteratively selecting neighboring geometric faces of the geometric mesh that meet one or more relative neighbor selection criteria into a region group; and
detecting an operable region indicated by the region group.
